SEQUENCE LISTING (20 sequences)

SEQ ID NO: 1 - DNA, 1452 bp, Bacillus licheniformis
  CDS (1)..(1449)
gcaaatcttaatgggacgctgatgcagtattttgaatggtacatgcccaatgacggccaacattggaagcgcttgcaaaacgactcggcatatttggctgaacacggtattactgccgtctggattcccccggcatataagggaacgagccaagcggatgtgggctacggtgcttacgacctttatgatttaggggagtttcatcaaaaagggacggttcggacaaagtacggcacaaaaggagagctgcaatctgcgatcaaaagtcttcattcccgcgacattaacgtttacggggatgtggtcatcaaccacaaaggcggcgctgatgcgaccgaagatgtaaccgcggttgaagtcgatcccgctgaccgcaaccgcgtaatttcaggagaacaccgaattaaagcctggacacattttcattttccggggcgcggcagcacatacagcgattttaaatggcattggtaccattttgacggaaccgattgggacgagtcccgaaagctgaaccgcatctataagtttcaaggaaaggcttgggattgggaagtttccaatgaaaacggcaactatgattatttgatgtatgccgacatcgattatgaccatcctgatgtcgcagcagaaattaagagatggggcacttggtatgccaatgaactgcaattggacggtttccgtcttgatgctgtcaaacacattaaattttcttttttgcgggattgggttaatcatgtcagggaaaaaacggggaaggaaatgtttacggtagctgaatattggcagaatgacttgggcgcgctggaaaactatttgaacaaaacaaattttaatcattcagtgtttgacgtgccgcttcattatcagttccatgctgcatcgacacagggaggcggctatgatatgaggaaattgctgaacagtacggtcgtttccaagcatccgttgaaagcggttacatttgtcgataaccatgatacacagccggggcaatcgcttgagtcgactgtccaaacatggtttaagccgcttgcttacgcttttattctcacaagggaatctggataccctcaggttttctacggggatatgtacgggacgaaaggagactcccagcgcgaaattcctgccttgaaacacaaaattgaaccgatcttaaaagcgagaaaacagtatgcgtacggagcacagcatgattatttcgaccaccatgacattgtcggctggacaagggaaggcgacagctcggttgcaaattcaggtttggcggcattaataacagacggacccggtggggcaaagcgaatgtatgtcggccggcaaaacgccggtgagacatggcatgacattaccggaaaccgttcggagccggttgtcatcaattcggaaggctggggagagtttcacgtaaacggcgggtcggtttcaatttatgttcaaagatag

SEQ ID NO: 2 - protein, 483 aa, Bacillus licheniformis
ANLNGTLMQYFEWYMPNDGQHWKRLQNDSAYLAEHGITAVWIPPAYKGTSQADVGYGAYDLYDLGEFHQKGTVRTKYGTKGELQSAIKSLHSRDINVYGDVVINHKGGADATEDVTAVEVDPADRNRVISGEHRIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNSTVVSKHPLKAVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 3 - DNA, 1452 bp, Bacillus amyloliquefaciens
  CDS (1)..(1449)
gtaaatggcacgctgatgcagtattttgaatggtatacgccgaacgacggccagcattggaaacgattgcagaatgatgcggaacatttatcggatatcggaatcactgccgtctggattcctcccgcatacaaaggattgagccaatccgataacggatacggaccttatgatttgtatgatttaggagaattccagcaaaaagggacggtcagaacgaaatacggcacaaaatcagagcttcaagatgcgatcggctcactgcattcccggaacgtccaagtatacggagatgtggttttgaatcataaggctggtgctgatgcaacagaagatgtaactgccgtcgaagtcaatccggccaatagaaatcaggaaacttcggaggaatatcaaatcaaagcgtggacggattttcgttttccgggccgtggaaacacgtacagtgattttaaatggcattggtatcatttcgacggagcggactgggatgaatcccggaagatcagccgcatctttaagtttcgtggggaaggaaaagcgtgggattgggaagtatcaagtgaaaacggcaactatgactatttaatgtatgctgatgttgactacgaccaccctgatgtcgtggcagagacaaaaaaatggggtatctggtatgcgaatgaactgtcattagacggcttccgtattgatgccgccaaacatattaaattttcatttctgcgtgattgggttcaggcggtcagacaggcgacgggaaaagaaatgtttacggttgcggagtattggcagaataatgccgggaaactcgaaaactacttgaataaaacaagctttaatcaatccgtgtttgatgttccgcttcatttcaatttacaggcggcttcctcacaaggaggcggatatgatatgaggcgtttgctggacggtaccgttgtgtccaggcatccggaaaaggcggttacatttgttgaaaatcatgacacacagccgggacagtcattggaatcgacagtccaaacttggtttaaaccgcttgcatacgcctttattttgacaagagaatccggttatcctcaggtgttctatggggatatgtacgggacaaaagggacatcgccaaaggaaattccctcactgaaagataatatagagccgattttaaaagcgcgtaaggagtacgcatacgggccccagcacgattatattgaccacccggatgtgatcggatggacgagggaaggtgacagctccgccgccaaatcaggtttggccgctttaatcacggacggacccggcggatcaaagcggatgtatgccggcctgaaaaatgccggcgagacatggtatgacataacgggcaaccgttcagatactgtaaaaatcggatctgacggctggggagagtttcatgtaaacgatgggtccgtctccatttatgttcagaaataa

SEQ ID NO: 4 - protein, 483 aa, Bacillus amyloliquefaciens
VNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGSKRMYAGLKNAGETWYDITGNRSDTVKIGSDGWGEFHVNDGSVSIYVQK

SEQ ID NO: 5 - DNA, 1446 bp, Artificial
  Fusion of Alpha-Amylase-Gene von B. licheniformis and B. amyloliquefaciens (AL34)
gtaaatggcacgctgatgcagtattttgaatggtatacgccgaacgacggccagcattggaaacgattgcagaatgatgcggaacatttatcggatatcggtattactgccgtctggattcccccggcatataagggaacgagccaagcggatgtgggctacggtgcttacgacctttatgatttaggggagtttcatcaaaaagggacggttcggacaaagtacggcacaaaaggagagctgcaatctgcgatcaaaagtcttcattcccgcgacattaacgtttacggggatgtggtcatcaaccacaaaggcggcgctgatgcgaccgaagatgtaaccgcggttgaagtcgatcccgctgaccgcaaccgcgtaatttcaggagaacaccgaattaaagcctggacacattttcattttccggggcgcggcagcacatacagcgattttaaatggcattggtaccattttgacggaaccgattgggacgagtcccgaaagctgaaccgcatctataagtttcaaggaaaggcttgggattgggaagtttccaatgaaaacggcaactatgattatttgatgtatgccgacatcgattatgaccatcctgatgtcgcagcagaaattaagagatggggcacttggtatgccaatgaactgcaattggacggtttccgtcttgatgctgtcaaacacattaaattttcttttttgcgggattgggttaatcatgtcagggaaaaaacggggaaggaaatgtttacggtagctgaatattggcagaatgacttgggcgcgctggaaaactatttgaacaaaacaaattttaatcattcagtgtttgacgtgccgcttcattatcagttccatgctgcatcgacacagggaggcggctatgatatgaggaaattgctgaacagtacggtcgtttccaagcatccgttgaaagcggttacatttgtcgataaccatgatacacagccggggcaatcgcttgagtcgactgtccaaacatggtttaagccgcttgcttacgcttttattctcacaagggaatctggataccctcaggttttctacggggatatgtacgggacgaaaggagactcccagcgcgaaattcctgccttgaaacacaaaattgaaccgatcttaaaagcgagaaaacagtatgcgtacggagcacagcatgattatttcgaccaccatgacattgtcggctggacaagggaaggcgacagctcggttgcaaattcaggtttggcggcattaataacagacggacccggtggggcaaagcgaatgtatgtcggccggcaaaacgccggtgagacatggcatgacattaccggaaaccgttcggagccggttgtcatcaattcggaaggctggggagagtttcacgtaaacggcgggtcggtttcaatttatgttcaaagatag

SEQ ID NO: 6 - protein, 481 aa, Artificial
  Synthetic Construct
VNGTLMQYFEWYTPNDGQHWKRLQNDAEHLSDIGITAVWIPPAYKGTSQADVGYGAYDLYDLGEFHQKGTVRTKYGTKGELQSAIKSLHSRDINVYGDVVINHKGGADATEDVTAVEVDPADRNRVISGEHRIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNSTVVSKHPLKAVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 7 - DNA, 1446 bp, Artificial
  Fusion of Alpha-Amylase-Gene von B. licheniformis and B. amyloliquefaciens (AL76)
gtaaatggcacgctgatgcagtattttgaatggtatacgccgaacgacggccagcattggaaacgattgcagaatgatgcggaacatttatcggatatcggaatcactgccgtctggattcctcccgcatacaaaggattgagccaatccgataacggatacggaccttatgatttgtatgatttaggagaattccagcaaaaagggacggtcagaacgaaatacggcacaaaaggagagctgcaatctgcgatcaaaagtcttcattcccgcgacattaacgtttacggggatgtggtcatcaaccacaaaggcggcgctgatgcgaccgaagatgtaaccgcggttgaagtcgatcccgctgaccgcaaccgcgtaatttcaggagaacaccgaattaaagcctggacacattttcattttccggggcgcggcagcacatacagcgattttaaatggcattggtaccattttgacggaaccgattgggacgagtcccgaaagctgaaccgcatctataagtttcaaggaaaggcttgggattgggaagtttccaatgaaaacggcaactatgattatttgatgtatgccgacatcgattatgaccatcctgatgtcgcagcagaaattaagagatggggcacttggtatgccaatgaactgcaattggacggtttccgtcttgatgctgtcaaacacattaaattttcttttttgcgggattgggttaatcatgtcagggaaaaaacggggaaggaaatgtttacggtagctgaatattggcagaatgacttgggcgcgctggaaaactatttgaacaaaacaaattttaatcattcagtgtttgacgtgccgcttcattatcagttccatgctgcatcgacacagggaggcggctatgatatgaggaaattgctgaacagtacggtcgtttccaagcatccgttgaaagcggttacatttgtcgataaccatgatacacagccggggcaatcgcttgagtcgactgtccaaacatggtttaagccgcttgcttacgcttttattctcacaagggaatctggataccctcaggttttctacggggatatgtacgggacgaaaggagactcccagcgcgaaattcctgccttgaaacacaaaattgaaccgatcttaaaagcgagaaaacagtatgcgtacggagcacagcatgattatttcgaccaccatgacattgtcggctggacaagggaaggcgacagctcggttgcaaattcaggtttggcggcattaataacagacggacccggtggggcaaagcgaatgtatgtcggccggcaaaacgccggtgagacatggcatgacattaccggaaaccgttcggagccggttgtcatcaattcggaaggctggggagagtttcacgtaaacggcgggtcggtttcaatttatgttcaaagatag

SEQ ID NO: 8 - protein, 481 aa, Artificial
  Synthetic Construct
VNGTLMQYFEWYTPNDGQHWKRLQNDAEHLSDIGITAVWIPPAYKGLSQSDNGYGPYDLYDLGEFQQKGTVRTKYGTKGELQSAIKSLHSRDINVYGDVVINHKGGADATEDVTAVEVDPADRNRVISGEHRIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNSTVVSKHPLKAVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 9 - DNA, 1446 bp, Artificial
  Fusion of Alpha-Amylase-Gene von B. licheniformis and B. amyloliquefaciens (AL112)
gtaaatggcacgctgatgcagtattttgaatggtatacgccgaacgacggccagcattggaaacgattgcagaatgatgcggaacatttatcggatatcggaatcactgccgtctggattcctcccgcatacaaaggattgagccaatccgataacggatacggaccttatgatttgtatgatttaggagaattccagcaaaaagggacggtcagaacgaaatacggcacaaaatcagagcttcaagatgcgatcggctcactgcattcccggaacgtccaagtatacggagatgtggttttgaatcataaggctggtgctgatgcaacagaagatgtaaccgcggttgaagtcgatcccgctgaccgcaaccgcgtaatttcaggagaacaccgaattaaagcctggacacattttcattttccggggcgcggcagcacatacagcgattttaaatggcattggtaccattttgacggaaccgattgggacgagtcccgaaagctgaaccgcatctataagtttcaaggaaaggcttgggattgggaagtttccaatgaaaacggcaactatgattatttgatgtatgccgacatcgattatgaccatcctgatgtcgcagcagaaattaagagatggggcacttggtatgccaatgaactgcaattggacggtttccgtcttgatgctgtcaaacacattaaattttcttttttgcgggattgggttaatcatgtcagggaaaaaacggggaaggaaatgtttacggtagctgaatattggcagaatgacttgggcgcgctggaaaactatttgaacaaaacaaattttaatcattcagtgtttgacgtgccgcttcattatcagttccatgctgcatcgacacagggaggcggctatgatatgaggaaattgctgaacagtacggtcgtttccaagcatccgttgaaagcggttacatttgtcgataaccatgatacacagccggggcaatcgcttgagtcgactgtccaaacatggtttaagccgcttgcttacgcttttattctcacaagggaatctggataccctcaggttttctacggggatatgtacgggacgaaaggagactcccagcgcgaaattcctgccttgaaacacaaaattgaaccgatcttaaaagcgagaaaacagtatgcgtacggagcacagcatgattatttcgaccaccatgacattgtcggctggacaagggaaggcgacagctcggttgcaaattcaggtttggcggcattaataacagacggacccggtggggcaaagcgaatgtatgtcggccggcaaaacgccggtgagacatggcatgacattaccggaaaccgttcggagccggttgtcatcaattcggaaggctggggagagtttcacgtaaacggcgggtcggtttcaatttatgttcaaagatag

SEQ ID NO: 10 - protein, 481 aa, Artificial
  Synthetic Construct
VNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVDPADRNRVISGEHRIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNSTVVSKHPLKAVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 11 - DNA, 1452 bp, Artificial
  Fusion of Alpha-Amylase-Gene von B. licheniformis and B. amyloliquefaciens (AL256)
gtaaatggcacgctgatgcagtattttgaatggtatacgccgaacgacggccagcattggaaacgattgcagaatgatgcggaacatttatcggatatcggaatcactgccgtctggattcctcccgcatacaaaggattgagccaatccgataacggatacggaccttatgatttgtatgatttaggagaattccagcaaaaagggacggtcagaacgaaatacggcacaaaatcagagcttcaagatgcgatcggctcactgcattcccggaacgtccaagtatacggagatgtggttttgaatcataaggctggtgctgatgcaacagaagatgtaactgccgtcgaagtcaatccggccaatagaaatcaggaaacttcggaggaatatcaaatcaaagcgtggacggattttcgttttccgggccgtggaaacacgtacagtgattttaaatggcattggtatcatttcgacggagcggactgggatgaatcccggaagatcagccgcatctttaagtttcgtggggaaggaaaagcgtgggattgggaagtatcaagtgaaaacggcaactatgactatttaatgtatgctgatgttgactacgaccaccctgatgtcgtggcagagacaaaaaaatggggtatctggtatgcgaatgaactgtcattagacggcttccgtattgatgccgccaaacatattaaattttcatttctgcgtgattgggttcaggcggtcagacaggcgacgggaaaagaaatgtttacggtagctgaatattggcagaatgacttgggcgcgctggaaaactatttgaacaaaacaaattttaatcattcagtgtttgacgtgccgcttcattatcagttccatgctgcatcgacacagggaggcggctatgatatgaggaaattgctgaacagtacggtcgtttccaagcatccgttgaaagcggttacatttgtcgataaccatgatacacagccggggcaatcgcttgagtcgactgtccaaacatggtttaagccgcttgcttacgcttttattctcacaagggaatctggataccctcaggttttctacggggatatgtacgggacgaaaggagactcccagcgcgaaattcctgccttgaaacacaaaattgaaccgatcttaaaagcgagaaaacagtatgcgtacggagcacagcatgattatttcgaccaccatgacattgtcggctggacaagggaaggcgacagctcggttgcaaattcaggtttggcggcattaataacagacggacccggtggggcaaagcgaatgtatgtcggccggcaaaacgccggtgagacatggcatgacattaccggaaaccgttcggagccggttgtcatcaattcggaaggctggggagagtttcacgtaaacggcgggtcggtttcaatttatgttcaaagatag

SEQ ID NO: 12 - protein, 483 aa, Artificial
  Synthetic Construct
VNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNDLGALENYLNKTNFNHSVFDVPLHYQFHAASTQGGGYDMRKLLNSTVVSKHPLKAVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 13 - DNA, 1452 bp, Artificial
  Fusion of Alpha-Amylase-Gene von B. licheniformis and B. amyloliquefaciens (ALA34-84)
gtaaatggcacgctgatgcagtattttgaatggtatacgccgaacgacggccagcattggaaacgattgcagaatgatgcggaacatttatcggatatcggtattactgccgtctggattcccccggcatataagggaacgagccaagcggatgtgggctacggtgcttacgacctttatgatttaggggagtttcatcaaaaagggacggttcggacaaagtacggcacaaaaggagagctgcaatctgcgatcggctcactgcattcccggaacgtccaagtatacggagatgtggttttgaatcataaggctggtgctgatgcaacagaagatgtaactgccgtcgaagtcaatccggccaatagaaatcaggaaacttcggaggaatatcaaatcaaagcgtggacggattttcgttttccgggccgtggaaacacgtacagtgattttaaatggcattggtatcatttcgacggagcggactgggatgaatcccggaagatcagccgcatctttaagtttcgtggggaaggaaaagcgtgggattgggaagtatcaagtgaaaacggcaactatgactatttaatgtatgctgatgttgactacgaccaccctgatgtcgtggcagagacaaaaaaatggggtatctggtatgcgaatgaactgtcattagacggcttccgtattgatgccgccaaacatattaaattttcatttctgcgtgattgggttcaggcggtcagacaggcgacgggaaaagaaatgtttacggttgcggagtattggcagaataatgccgggaaactcgaaaactacttgaataaaacaagctttaatcaatccgtgtttgatgttccgcttcatttcaatttacaggcggcttcctcacaaggaggcggatatgatatgaggcgtttgctggacggtaccgttgtgtccaggcatccggaaaaggcggttacatttgttgaaaatcatgacacacagccgggacagtcattggaatcgacagtccaaacttggtttaaaccgcttgcatacgcctttattttgacaagagaatccggttatcctcaggtgttctatggggatatgtacgggacaaaagggacatcgccaaaggaaattccctcactgaaagataatatagagccgattttaaaagcgcgtaaggagtacgcatacgggccccagcacgattatattgaccacccggatgtgatcggatggacgagggaaggtgacagctccgccgccaaatcaggtttggccgctttaatcacggacggacccggcggatcaaagcggatgtatgccggcctgaaaaatgccggcgagacatggtatgacataacgggcaaccgttcagatactgtaaaaatcggatctgacggctggggagagtttcatgtaaacgatgggtccgtctccatttatgttcagaaataa

SEQ ID NO: 14 - protein, 483 aa, Artificial
  Synthetic Construct
VNGTLMQYFEWYTPNDGQHWKRLQNDAEHLSDIGITAVWIPPAYKGTSQADVGYGAYDLYDLGEFHQKGTVRTKYGTKGELQSAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGSKRMYAGLKNAGETWYDITGNRSDTVKIGSDGWGEFHVNDGSVSIYVQK

SEQ ID NO: 15 - DNA, 1458 bp, Artificial
  Fusion of Alpha-Amylase-Gene von B. licheniformis and B. amyloliquefaciens (LAL19-433)
gcaaatcttaatgggacgctgatgcagtattttgaatggtacatgcccaatgacggccagcattggaaacgattgcagaatgatgcggaacatttatcggatatcggaatcactgccgtctggattcctcccgcatacaaaggattgagccaatccgataacggatacggaccttatgatttgtatgatttaggagaattccagcaaaaagggacggtcagaacgaaatacggcacaaaatcagagcttcaagatgcgatcggctcactgcattcccggaacgtccaagtatacggagatgtggttttgaatcataaggctggtgctgatgcaacagaagatgtaactgccgtcgaagtcaatccggccaatagaaatcaggaaacttcggaggaatatcaaatcaaagcgtggacggattttcgttttccgggccgtggaaacacgtacagtgattttaaatggcattggtatcatttcgacggagcggactgggatgaatcccggaagatcagccgcatctttaagtttcgtggggaaggaaaagcgtgggattgggaagtatcaagtgaaaacggcaactatgactatttaatgtatgctgatgttgactacgaccaccctgatgtcgtggcagagacaaaaaaatggggtatctggtatgcgaatgaactgtcattagacggcttccgtattgatgccgccaaacatattaaattttcatttctgcgtgattgggttcaggcggtcagacaggcgacgggaaaagaaatgtttacggttgcggagtattggcagaataatgccgggaaactcgaaaactacttgaataaaacaagctttaatcaatccgtgtttgatgttccgcttcatttcaatttacaggcggcttcctcacaaggaggcggatatgatatgaggcgtttgctggacggtaccgttgtgtccaggcatccggaaaaggcggttacatttgttgaaaatcatgacacacagccgggacagtcattggaatcgacagtccaaacttggtttaaaccgcttgcatacgcctttattttgacaagagaatccggttatcctcaggtgttctatggggatatgtacgggacaaaagggacatcgccaaaggaaattccctcactgaaagataatatagagccgattttaaaagcgcgtaaggagtacgcatacgggccccagcacgattatattgaccacccggatgtgatcggatggacgagggaaggtgacagctccgccgccaaatcaggtttggccgctttaatcacggacggacccggtggggcaaagcgaatgtatgtcggccggcaaaacgccggtgagacatggcatgacattaccggaaaccgttcggagccggttgtcatcaattcggaaggctggggagagtttcacgtaaacggcgggtcggtttcaatttatgttcaaagatag

SEQ ID NO: 16 - protein, 485 aa, Artificial
  Synthetic Construct
ANLNGTLMQYFEWYMPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGAKRMYVGRQNAGETWHDITGNRSEPVVINSEGWGEFHVNGGSVSIYVQR

SEQ ID NO: 17 - DNA, 1452 bp, Artificial
  Fusion of Alpha-Amylase-Gene von B. licheniformis and B. amyloliquefaciens (LAL19-153)
gcaaatcttaatgggacgctgatgcagtattttgaatggtacatgcccaatgacggccagcattggaaacgattgcagaatgatgcggaacatttatcggatatcggaatcactgccgtctggattcctcccgcatacaaaggattgagccaatccgataacggatacggaccttatgatttgtatgatttaggagaattccagcaaaaagggacggtcagaacgaaatacggcacaaaatcagagcttcaagatgcgatcggctcactgcattcccggaacgtccaagtatacggagatgtggttttgaatcataaggctggtgctgatgcaacagaagatgtaactgccgtcgaagtcaatccggccaatagaaatcaggaaacttcggaggaatatcaaatcaaagcgtggacggattttcgttttccgggccgtggaaacacgtacagtgattttaaatggcattggtaccattttgacggaaccgattgggacgagtcccgaaagctgaaccgcatctataagtttcaaggaaaggcttgggattgggaagtttccaatgaaaacggcaactatgattatttgatgtatgccgacatcgattatgaccatcctgatgtcgcagcagaaattaagagatggggcacttggtatgccaatgaactgcaattggacggtttccgtcttgatgctgtcaaacacattaaattttcttttttgcgggattgggttaatcatgtcagggaaaaaacggggaaggaaatgtttacggtagctgaatattggcagaatgacttgggcgcgctggaaaactatttgaacaaaacaaattttaatcattcagtgtttgacgtgccgcttcattatcagttccatgctgcatcgacacagggaggcggctatgatatgaggaaattgctgaacagtacggtcgtttccaagcatccgttgaaagcggttacatttgtcgataaccatgatacacagccggggcaatcgcttgagtcgactgtccaaacatggtttaagccgcttgcttacgcttttattctcacaagggaatctggataccctcaggttttctacggggatatgtacgggacgaaaggagactcccagcgcgaaattcctgccttgaaacacaaaattgaaccgatcttaaaagcgagaaaacagtatgcgtacggagcacagcatgattatttcgaccaccatgacattgtcggctggacaagggaaggcgacagctcggttgcaaattcaggtttggcggcattaataacagacggacccggtggggcaaagcgaatgtatgtcggccggcaaaacgccggtgagacatggcatgacattaccggaaaccgttcggagccggttgtcatcaattcggaaggctggggagagtttcacgtaaacggcgggtcggtttcaatttatgttcaaagatag

SEQ ID NO: 18 - protein, 483 aa, Artificial
  Synthetic Construct
ANLNGTLMQYFEWYMPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNSTVVSKHPLKAVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 19 - protein, 512 aa, Bacillus licheniformis
MKQQKRLYARLLTLLFALIFLLPHSAAAAANLNGTLMQYFEWYMPNDGQHWKRLQNDSAYLAEHGITAVWIPPAYKGTSQADVGYGAYDLYDLGEFHQKGTVRTKYGTKGELQSAIKSLHSRDINVYGDVVINHKGGADATEDVTAVEVDPADRNRVISGEHRIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNSTVVSKHPLKAVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 20 - protein, 514 aa, Bacillus amyloliquefaciens
MIQKRKRTVSFRLVLMCTLLFVSLPITKTSAVNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGSKRMYAGLKNAGETWYDITGNRSDTVKIGSDGWGEFHVNDGSVSIYVQK

(19) United States
(12) Patent Application Publication
(10) Pub. No.: US 2005/0049165 A1
(43) Pub. Date: Mar. 3, 2005

(54) Detergent and cleaning agent with hybrid alpha-amylases

(76) Inventors: Beatrix Kottwitz, Erkrath (DE); Roland Breves, Mettmann (DE); Karl-Heinz Maurer, Erkrath (DE)

Correspondence Address: WOODCOCK WASHBURN LLP, ONE LIBERTY PLACE, 46TH FLOOR, PHILADELPHIA, PA, 19103, US

(21) Appl. No.: 10/774,018

(22) Filed: Feb. 6, 2004

Related U.S. Application Data
(63) Continuation of application No. PCT/EP02/08391, filed on Jul. 27, 2002.

(30) Foreign Application Priority Data
Aug. 7, 2001 (DE) DE 101 38 753.9

(51) Int. Cl. C11D 3/386

(52) U.S. Cl. 510/392; 510/530

(57) ABSTRACT

The present invention relates compositions and methods involving hybrid α-amylases derived from the α-amylases of the bacteria species Bacillus amyloliquefaciens and Bacillus licheniformis. In one embodiment, the hybrid α-amylases are used in detergents and cleaning agents.

### CROSS REFERENCE TO RELATED APPLICATIONS

This is application is a continuation of International Application No.

PCT/EP02/08391, filed Jul. 27, 2002, which claims priority to German Application No. DE 101 38 753, filed Aug. 7, 2001, all of which are incorporated herein by reference in their entireties.

The present invention relates to detergents and cleaning agents with hybrid α-amylases derived from the α-amylases of the bacterial species Bacillus amyloliquefaciens and Bacillus licheniformis, to methods for cleaning textiles or hard surfaces, which involve such proteins or corresponding agents and to the use of such proteins or corresponding agents for cleaning textiles or hard surfaces. The invention furthermore relates to a method for improving the performance of detergents and cleaning agents by forming hybrid amylases of the α-amylases of the bacterial species B. amyloliquefaciens and B. licheniformis and adding said hybrid amylases to the agents in question.

α-Amylases (E.C. 3.2.1.1) hydrolyzed internal α-1,4-glycosidic bonds of starch and starch-like polymers such as, for example, amylase, amylopectin or glycogen, with the formation of dextrins and β-1,6-branched oligosaccharides. They are very much among the most important industrially utilized enzymes, for two reasons: on the one hand, they are released by microorganisms into the surrounding medium so that it is possible to obtain them on an industrial scale by fermentation and purification from the culture medium with comparatively little effort. On the other hand, amylases are required for a broad spectrum of applications.

An important industrial use of α-amylase is its use as active component in detergents and cleaning agents. Its contribution to the washing and, respectively, cleaning performance of the agent in question is the breakdown of starchy stains. The hydrolysis products are attached, dissolved, emulsified or suspended by the other components of the detergent or cleaning agents or are washed away with the wash liquor, owing to their relatively high solubility, so that advantageously synergistic effects between the enzyme and the other components of said agents arise.

An intensive search for α-amylase from natural sources, which might be suitable for use in detergents and cleaning agents, is carried out. Starch-cleaving enzymes, for example from Pimelobacter, Pseudomonas and Thermus, for food production, cosmetics and pharmaceuticals (EP 636693), and enzymes of the same kind from Rhizobium, Arthrobacter, Brevibacterium and Micrococcus (EP 628630), from Pyrococcus (WO 94/19454) and Sulfolobus for starch liquefaction at elevated temperatures and strongly acidic reaction conditions (EP 727485 and WO 96/02633, respectively) have been identified. Bacillus sp. amylases (WO 95/26397 and WO 97/00324) have been found for the use of alkali pH. Due to their low sensitivity to detergents, other amylases from various Bacilli (EP 670367) are suitable for use in detergents or cleaning agents. And Thermoalcalibacter amylase (WO 98/13481) is largely insensitive to calcium ions so that it is well qualified for the use in detergents from the outset.

An α-amylase frequently used in detergents and cleaning agents is the one from Bacillus licheniformis. The corresponding product from Novozymes A/S, Bagsvaerd, Denmark, for example, has the trade name Termamyl®; the product from Genencor Int., Rochester, N.Y., USA, is called Purastar®. The α-amylase produced by B. amyloliquefaciens and fermentatively producible, for example, by B. subtilis according to U.S. Pat. No. 1,227,374 is sold by Novozymes A/S under the name BAN@. The sequences of the B. licheniformis, B. amyloliquefaciens α-amylases and that of B. stearothermophilus α-amylase are stated, for example, in the application WO 96/23874.

These amylase molecules, and close relatives thereof, have been further developed in numerous inventions, in particular via molecular-biological modifications, in order to be optimized with regard to specific applications, in particular their use in detergents and cleaning agents. Such optimizations may concern, for example, substrate specificities, stability of the enzyme under various conditions or the enzymic activity itself.

One principle of these further developments consists of using point mutations to improve the properties. The application WO 96/23873, for example, discloses for the use in detergents and cleaning agents improved variants of those α-amylases which were known as wild-type enzymes or are derived from microorganisms which had previously been described as producers of alkaline proteases. The mutagenesis method of application WO 99/20768, for example, results in α-amylase variants which are particularly stable in the presence of cleaning agent components. In modifications of this kind, a change in individual enzymic properties virtually always also affects other properties and the performance of the enzyme in question. An example of an optimization product obtained in this way and since commercially marketed is Duramyl® (WO 94/02597) which has reduced sensitivity to oxidation (Novozymes; SÖFW-Journal, 123, (1997), pp. 723-731).

Other examples are: the amylases of application WO 99/02702 are more stable than the starting molecule at relatively high temperatures. The enzymes of application WO 99/23211 are stable at high pH, in the presence of calcium ions and at relatively high temperatures. The α-amylases of application WO 97/43424 exhibit a changed calcium ion-binding behavior and thus changed enzymic properties.

A different or additionally to be used optimization method comprises, for example, chemical modifications (DE 4013142).

The patent application WO 99/43793, for example, applies another principle for further development of known α-amylases. This involves making use of sequence similarities between Novamyl® and known cyclodextrin glucanotransferases (CGTases) in order to recombine relatively large molecule parts with the aid of molecular-biological techniques and thus to construct a host of related molecules. The latter are α-amylases with additional CGTase-specific consensus sequences (boxes) and functions or, conversely, CGTases with additional regions and functions typical for α-amylases or they are chimeras of both molecules.

The application WO 99/57250 discloses a comparable method of how to enable the washing performance of detergent enzymes to be increased. The principle described there comprises binding the enzymes in question covalently via a non-amino acid linker to cellulose-binding domains (CBD) of bacterial origin. The latter ensure that the enzyme becomes increasingly active on the surface of the textile. The document WO 99/57252 includes in this concept other possible linkers, and the document WO 99/57254 includes other enzymes such as, for example, glycosyl transferases or acyl transferases which are bound to the CBD either with formation of a chimeric protein or via the linkers mentioned in WO 99/57252.

The necessity for all these further developments of the α-amylases established for use in detergents and cleaning agents arises, for example, from newly developed ingredients which, like bleaches, for example, drastically influence the particular conditions and impair the efficiency of the enzymes. It arises, however, also from the various cleaning purposes, from the changing habits and demands of consumers, according to which, for example, there is an increasing demand for detergents for cleaning at low and medium temperatures.

The technique of preparing fusions or hybrid proteins is well established in the prior art. Thus, for example, application EP 208491 describes an in-vivo method for preparing hybrid proteins, which is based on cloning the corresponding DNA sections one behind the other into a vector. This includes, for example, also hybrid amylases whose N-terminal region corresponds to that of B. stearothermophilus α-amylase and whose C-terminal region corresponds to that of B. licheniformis α-amylase.

The application WO 96/23874 discloses hybrids of the α-amylases from Bacillus licheniformis, B. amyloliquefaciens, B. stearothermophilus and Aspergillus oryzae. Among these, there is specifically one whose amino acids 1-300 derive from B. amyloliquefaciens α-amylase and 301-483 from B. licheniformis α-amylase; thus, according to the terminology of the present application (see below), it could be referred to as AL300. A variant AL37 is also referred to therein. According to the teaching of this application, such hybrid amylases may be prepared for determining the three-dimensional structure of the Termamyl-like amylases, in order to detect on the basis of the latter those positions which are important for enzymic activity. Said positions may then be specifically altered by site-directed mutagenesis and be supplied to appropriate applications. Accordingly, both individual positions and specific substitutions for said positions are mentioned, which can be used to vary the enzymic properties. This document discloses no further possible industrial uses for the hybrid amylases themselves which have not been subject to point mutations.

Based on these findings-, WO 97/41213 discloses further variants to be obtained by point mutagenesis, both of the wild-type enzymes and of individual hybrid amylases, including AL37, also for use in detergents and cleaning agents.

The application WO 00/60059 discloses variants which have been developed with respect to an altered cleavage pattern on the substrate starch and which are therefore particularly suitable for the processing of starch; for this, according to said application, generating long branched oligosaccharides is more advantageous than generating shorter branched oligosaccharides. Said document discloses numerous point mutations both of native α-amylases and of hybrid amylases, such as, for example, AL33 and AL37 (whose sequences are identical), which, inter alia, may also contain a mutation in position 412 (according to the counting of B. licheniformis), preferably T412A; in addition to this, however, at least a second mutation must be present in any of positions 13, 48 to 54, 57, 107, 108, 111, 168 and 197; preference is given to multiple mutants with still further substitutions.

None of the last-mentioned three documents discloses, according to numbering of B. amyloliquefaciens, positions 17, 34 (corresponding to 36 according to the numbering of B. licheniformis), 76, 108, 112, 142, 147, 149, 151, 163, 174, 179, 185, 191, 198, 207, 231, 234, 244, 256, 263, 276, 431, 84, 99, 429, 201, 19, 433 or 153 as points of fusion. Likewise, no hybrid amylases with sequence variations in positions 134 or 320 (counting according to B. licheniformis) are disclosed, and disclosure of a mutation in position 412 took place in combination with further defined variation and in connection with a special change in enzymic activity.

It was therefore the object to provide detergents and cleaning agents comprising novel amylolytic enzymes or amylolytic enzymes not previously known, at least for this field of use, preferably comprising those which exhibit superior washing or cleaning performances than the established α-amylases.

Part of the object was to provide methods for cleaning textiles or hard surfaces, which, due to amylases of this kind, have improved results with respect to washing and cleaning performance.

A second part of the object was to show possible uses with correspondingly improved performances.

A third part of the object was to show methods according to which the performance of a detergent and cleaning agent can be improved by developing new amylases.

This object is achieved by providing hybrid proteins which may be formed from the α-amylases from the bacteria species Bacillus amyloliquefaciens and Bacillus licheniformis via fusion of appropriately matching parts.

The surprising fact of this solution is that even recombination of sequences of natural and long-established α-amylases alone can produce more efficient amylases for detergents or cleaning agents. These hybrid amylases may serve as a starting point for specific developments with respect to this field of use.

The invention thus relates to detergents or cleaning agents characterized in that they comprise an amylolytic hybrid protein whose amino acid sequence comprises in each case in a homologous position at least one partial sequence in encompassing more than one amino acid, which partial sequence is identical to that of Bacillus amyloliquefaciens α-amylase, and comprises in each case in a homologous position at least one partial sequence encompassing more than one amino acid, this partial sequence being identical to that of Bacillus licheniformis α-amylase. Among these, preference is given to those agents for which the partial sequences of the hybrid amylases, which can be traced back to the starting molecules, are more than 7, preferably more than 14, particularly preferably from 21 to 462, amino acids in length and/or for which the hybrid protein is composed of 3 or of 2 partial sequences complementing one another according to the starting sequences.

This object is preferably achieved by agents whose hybrid amylases have points of fusion close to positions 17, 34, 76, 108, 112, 142, 147, 149, 151, 163, 174, 179, 185, 191, 198, 207, 231, 234, 244, 256, 263, 276, 431, 84, 99, 429, 201, 19, 433 and 153 according to the numbering of B. amyloliquefaciens α-amylase (SEQ ID No. 4); namely, increasingly preferably, within regions of 10 or 5 amino acids upstream and downstream of said positions, or exactly at said positions. Among these, particular preference is given to the hybrid amylases AL17, AL108, AL142, AL147, AL149, AL151, AL163, AL174, AL179, AL185, AL191, AL198, AL207, AL231, AL234, AL244, AL263, AL276, AL431, ALA17-151, ALA76-151, ALA99-429, ALA12-151, ALA112-201, LA19 and LA431.

This object is particularly preferably achieved by agents whose hybrid amylases have points of fusion close to positions 34, 256, 84, 19 and 153 according to the numbering of B. amyloliquifaciens α-amylase (SEQ ID No. 4); namely, increasingly preferably, within regions of 10 or 5 amino acids upstream and downstream of said positions or exactly at said positions. Among these, particular preference is given to the hybrid amylases AL34 (SEQ ID No. 6), AL256 (SEQ ID No. 12), ALA34-84 (SEQ ID No. 14) and LAL19-153 (SEQ ID No. 18).

This object is very particularly preferably achieved by agents whose hybrid amylases have, as partial sequence, the partial sequence of amino acid positions 19 to 76 of Bacillus amyloliquefaciens α-amylase (SEQ ID No. 4) and, as further partial sequence, the partial sequence of amino acid positions 433 to 483 of Bacillus licheniformis α-amylase (SEQ ID No. 2). Among these, particular preference is given to the hybrid amylases AL76 (SEQ ID No. 8), AL112 (SEQ ID No. 10) and LAL19-433 (SEQ ID No. 16) and to the molecules which are in each case at least 98%, preferably 99%, particularly preferably 100%, identical thereto. Included here are variants obtainable by point mutagenesis, for example by substitution of individual amino acids.

This object is furthermore achieved by agents whose hybrid amylases are obtainable by deletions of short regions encompassing no more than 5 amino acids, insertion mutagenesis or derivatization or share with the aforementioned proteins an antigenic determinant produced by formation of the hybrid.

The detergents or cleaning agents of this subject matter of the invention preferably contain the hybrid amylase in proportions of from 0.000001 percent by weight to 5% by weight, in particular 0.00001 to 3% by weight, and/or further enzymes; they may be present in presentations known per se or aggregates or multiple phases, or the amylolytic activity therein may fulfill a function for the release of the ingredients of the agent or may be regulated itself.

Part of the object is achieved by methods for cleaning textiles or hard surfaces, which thus form the second subject matter of the invention and which are characterized in that in at least one of the method steps a hybrid amylase, or an agent of the first subject matter of the invention, is used. Said hybrid amylase is used in the method step in question preferably in an amount of from 0.01 mg to 400 mg, preferably from 0.02 mg to 200 mg, particularly preferably from 0.02 to 100 mg, per application.

The second part of the object is achieved by appropriate possible uses of the hybrid amylases relevant to the invention for cleaning textiles or hard surfaces or for releasing the ingredients of corresponding agents, which uses thus form the third subject matter of the invention; used per application in a dishwasher or a washing machine preferably in an amount of from 0.01 mg to 400 mg, preferably from 0.02 mg to 200 mg, particularly preferably from 0.02 to 100 mg, per application.

The third part of the object is achieved by all methods for improving the performance of detergents or cleaning agents, which methods represent a separate subject matter of the invention and are based on the development of hybrid amylases which for their part are fused by fusion of partial sequences comprising in each case at least more than one amino acid of the α-amylases from Bacillus amyloliquefaciens and Bacillus licheniformis in each case in a homologous position to give an amylolytically active hybrid amylase and which are added to the agent.

Preference is accordingly given to those solutions which are based on the previously discussed hybrid amylases and very particularly on the sequence information about the natural genes from B. amyloliquefaciens and B. licheniformis (SEQ ID No. 3 and SEQ ID No. 1), which is provided by the present application.

A protein means in accordance with the present application a polymer which is composed of the natural amino acids, has a substantially linear structure and adopts usually a three-dimensional structure to exert its function. In the present application, the 19 proteinogenic, naturally occurring L-amino acids are indicated by the internationally customary 1- and 3-letter codes.

An enzyme in accordance with the present application means a protein which exerts a particular biochemical function. Amylolytic proteins or enzymes with amylolytic function mean those which hydrolyze α-1,4-glycosidic bonds of polysaccharides, in particular those bonds located inside the polysaccharides, and which may therefore also be referred to as a-1,4-amylases (E.C. 3.2.1.1) or α-amylases for short.

Numerous proteins are formed as “preproteins” (precursor proteins), i.e. together with a signal or leader peptide. This then means the N-terminal part of the protein, whose function usually is to ensure the export of the produced protein from the producing cell into the periplasma or into the surrounding medium and/or the correct folding thereof. In contrast, however, for industrial applications, for example also within the scope of the present invention, preference is given to the mature peptides, i.e. the enzymes processed after their production, rather than to the preproteins, due to the enzymic activity of the former.

Nucleic acids mean in accordance with the present application the molecules which are naturally composed of nucleotides, serve as information carriers and code for the linear amino acid sequence in proteins or enzymes. They may be present as single strand, as a single strand complementary to said single strand or as double strand. For molecular-biological work, preference is given to the nucleic acid DNA as the naturally more durable information carrier. In contrast, an RNA is produced to implement the invention in a natural environment such as, for example, in an expressing cell.

In the case of DNA, the sequences of both complementary strands in each case in all three possible reading frames must be taken into account. The fact that different codon triplets can code for the same amino acids so that a particular amino acid sequence can be derived from a plurality of different nucleotide sequences which possibly have only low identity must also be taken into account (degeneracy of the genetic code). Moreover, various organisms differ in the use of these codons. For these reasons, both amino acid sequences and nucleotide sequences must be incorporated into the scope of protection, and nucleotide sequences indicated are in each case to be regarded only as coding by way of example for a particular amino acid sequence.

The information unit corresponding to a protein is also referred to as a gene in accordance with the present application.

It is possible for a skilled worker, via nowadays generally known methods such as, for example, chemical synthesis or polymerase chain reaction (PCR) in combination with molecular-biological and/or protein-chemical standard methods, to prepare the appropriate nucleic acids up to complete genes on the basis of known DNA sequences and/or amino acid sequences. Such methods are known, for example, from the “Lexikon der Biochemie” [Encyclopedia of Biochemistry], Spektrum Akademischer Verlag, Berlin, 1999, Volume 1, pp. 267-271 and Volume 2, pp. 227-229.

Changes in the nucleotide sequence, as may be produced, for example, by molecular-biological methods known per se, are referred to as mutations. Depending on the type of change, deletion, insertion or substitution mutations, for example, or those in which various genes or parts of genes are fused to one another (shuffling) are known; these are gene mutations. The corresponding organisms are referred to as mutants. The proteins derived from mutated nucleic acids are referred to as variants. Thus, for example, deletion, insertion or substitution mutations or fusions result in deletion-, insertion- or substitution-mutated or fusion genes and, at the protein level, to corresponding deletion, insertion or substitution variants, or fusion proteins. In the present application, mutations are indicated via the usual one-letter codes. Thus, for example, the point mutation T410A is a substitution in position 410 of the protein in question, in which the amino acid alanine has been substituted for the amino acid threonine.

Fragments mean all proteins or peptides which are smaller than natural proteins or those which correspond to completely translated genes, and which may also be obtained synthetically, for example. Owing to their amino acid sequences, they may be related to the corresponding complete proteins. They may adopt, for example, identical structures or exert amylolytic activities or partial activities such as complexing of a substrate, for example. Fragments and deletion variants of starting proteins are in principle very similar; while fragments represent relatively small pieces, the deletion mutants lack only short regions and thus only individual partial functions.

The equivalents of fragments at the nucleic acid level are partial sequences.

Chimeric or hybrid proteins mean in accordance with the present application those proteins which are composed of elements which naturally originate from different polypeptide chains from the same organism or from different organisms. This procedure is also called shuffling or fusion mutagenesis. The purpose of such a fusion may be, for example, to cause or to modify a particular enzymic function with the aid of the fused-to protein part or to obtain enzymes which have, in any regard, improved properties.

Proteins obtained by insertion mutation mean those variants which have been obtained via methods known per se by inserting a nucleic acid fragment or protein fragment into the starting sequences. They should be classified as chimeric proteins, due to their similarity in principle. They differ from the latter merely in the size ratio of the unaltered protein part to the size of the entire protein. In such insertion-mutated proteins the proportion of foreign protein is lower than in chimeric proteins.

Inversion mutagenesis, i.e. a partial sequence conversion, may be regarded as a special form of both deletion and insertion. The same applies to a regrouping of various molecule parts, which deviate from the original amino acid sequence. Said regrouping can be regarded as deletion variant, as insertion variant and as shuffling variant of the original protein.

Derivatives mean in accordance with the present application those proteins whose pure amino acid chain has been chemically modified. Those derivatizations may be carried out, for example, biologically in connection with protein biosynthesis by the host organism. Molecular-biological methods may be employed here. However, said derivatizations may also be carried out chemically, for example by chemical conversion of an amino acid side chain or by covalent binding of another compound to the protein. Such a compound may be, for example, other proteins which are bound, for example, via bifunctional chemical compounds to proteins of the invention. Likewise, derivatization means covalent binding to a macromolecular support.

Proteins may also be grouped via the reaction with an antiserum or with a particular antibody into groups of immunologically related proteins. The members of a group are distinguished in that they have the same antigenic determinant recognized by an antibody.

In accordance with the present invention, all enzymes, proteins, fragments and derivatives, unless they need to be explicitly referred to as such, are included under the generic term proteins.

Comparison with known enzymes which are deposited, for example, in generally accessible databases makes it possible to derive characteristic molecule parts such as, for example, structural elements or the enzymic activity of an enzyme under consideration from the amino acid sequence or nucleotide sequence.

Such a comparison is carried out by relating similar sequences in the nucleotide or amino acid sequences of the proteins under consideration to one another. This is called homologization. Relating the relevant positions in the form of a table is referred to as alignment. When analyzing nucleotide sequences, again both complementary strands and in each case all three possible reading frames must be taken into account, likewise the degeneracy of the genetic code and the organism-specific codon usage. Meanwhile, alignments are produced by computer programs, for example by the FASTA or BLAST algorithms; this procedure is described, for example, by D. J. Lipman and W. R. Pearson (1985) in Science, Volume 227, pp. 1435-1441. A compilation of all matching positions in the compared sequences is referred to as consensus sequence.

Such a comparison also allows a statement about the similarity or homology of the compared sequences to one another. This is expressed in percent identity, i.e. the proportion of the identical nucleotides or amino acid residues at the same positions. A wider definition of the term homology also includes the conserved amino acid substituents in this value. This is then referred to as percent similarity. Such statements may be made about whole proteins or genes or only about individual regions.

Homologous regions of different proteins are usually those having the same structural elements and/or functions which can be recognized by matches in the primary amino acid sequence. This ranges up to complete identities in very small regions, the “boxes”, which comprise only a few amino acids and usually exert functions essential for the overall activity. The functions of the homologous regions mean very small partial functions of the function exerted by the complete protein, such as, for example, the formation of individual hydrogen bonds for complexing a substrate or transition complex.

The identification of homologous regions between at least two proteins is the basis of combining said proteins to fusion or hybrid proteins with comparable function. In this connection, at least one region of one protein is replaced by the homologous region of the other protein. Thus, the fused regions must fit together, retaining the principle function of the whole protein. If the fusion is, for example, one of partial sequences of two amylases, then, according to the invention, a hybrid amylase is obtained when the fusion product itself overall has amylolytic activity.

The enzymic activity may be modified qualitatively or quantitatively by other regions of the protein, which are not involved in the actual reaction. This relates, for example, to enzyme stability, activity, reaction conditions or substrate specificity.

Proteins may also be combined in groups of immunologically related proteins via reaction with an antiserum or a particular antibody. The members of a group are distinguished by having the same antigenic determinant recognized by an antibody.

The performance of an enzyme means its efficacy in the industrial area considered in each case. Said performance is based on the actual enzymic activity but, in addition, depends on further factors relevant for the particular process. These include, for example, stability, substrate binding, interaction with the material carrying said substrate or interactions with other ingredients, in particular synergies. Thus, for example, the study of whether an enzyme is suitable for use in detergents or cleaning agents considers its contribution to the washing or cleaning performance of an agent formulated with further components.

According to the invention, the proteins essential to the invention are used in detergents or cleaning agents in which preferably those are used whose enzymic activity contributes to improving the performance of at least one detergent or cleaning agent formulation on at least one starchy or starch-like stain on at least one surface. Particular preference is given to those which contribute to the washing or cleaning performance of the agent(s) in question in more than one cleaning problem.

Said surfaces are preferably textiles or hard surfaces. The conditions to be chosen for this, such as, for example, temperature, pH, ionic strength, redox states or mechanical influences, should be optimized for the particular cleaning problem, i.e. with respect to the stain and the carrier material. Thus, usual temperatures for detergents and cleaning agents range from 10° C. for manual agents, over 40° C. and 60° C. up to 95° for machine agents or industrial applications. Preferably, the ingredients of the agents in question are also adjusted to one another.

The hybrid amylases which characterize the agents of the invention are composed in homologous complementation of partial sequences of the α-amylases of Bacillus amyloliquefaciens and of Bacillus licheniformis, i.e. each amino acid of the hybrid amylases in question is located in a partial region which encompasses at least two amino acids and which may be found in homologous position either in the one or the other starting sequence. This can be understood, for example, on the basis of the alignment of FIG. 2.

The sequences of these two starting enzymes may be obtained from publically accessible databases by the names amyA (for B. amyloliquefaciens α-amylase) or amyL (for B. licheniformis α-amylase). In the Swiss-Prot database (Geneva Bioinformatics (GeneBio) S. A., Geneva, Switzerland; http://www.genebio.com/sprot.html), for example, they are listed under the accession numbers P00692 (for B. amyloliquefaciens α-amylase amyA) and P06278 (for B. licheniformis α-amylase amyL). In addition, they are indicated in the sequence listing of the present application under SEQ ID No. 4 and SEQ ID No. 2, respectively; together with the corresponding nucleotide sequences under SEQ ID No. 3 and SEQ ID No. 1, respectively.

Both Bacillus species have been described in detail in the literature and are also generally accessible via strain collections. Thus, for example, B. amyloliquefaciens is obtainable under the name DSM 7 from the Deutsche Sammlung von Mikroorganismen und Zellkulturen GmbH, Mascheroder Weg lb, 38124 Braunschweig, Germany (http://www.dsmz.de) or under the name ATCC 23350 from the American Type Culture Collection, 10801 University Boulevard, Manassas, Va. 20110-2209, USA (http://www.atcc.org). B licheniformis may be obtained from the same sites, for example under the names DSM 13, and ATCC 14580, respectively.

From these strains, the corresponding α-amylase genes may be obtained, for example, via PCR using those primers which have been synthesized on the basis of the sequence listing of the present application (SEQ ID No. 3 and SEQ ID No. 1, respectively). The PCR products obtained may be cloned according to methods known per se and further processed in any convenient manner (see below).

According to the invention, appropriate hybrid classes can be defined and named on the basis of the starting sequences. If the letter L is chosen for the amylase from B. licheniformis and the letter A is chosen for that from B. amyloliquefaciens, then an enzyme whose N-terminal sequence is that of B. licheniformis α-amylase and whose C-terminal sequence is that of B. amyloliquefaciens α-amylase belongs to the hybrid class LA. With reverse composition, it would belong to the hybrid class AL, and with fusion of three parts, correspondingly to the hybrid classes LAL or ALA, depending on which partial sequences of the starting enzymes have been combined.

Additional numbers characterize the molecule unambiguously with respect to the site at which, i.e. to the amino acid C-terminally from which, fusion has taken place. If in doubt, the counting of B. amyloliquefaciens α-amylase (SEQ ID No. 4) is definitive. Thus, for example, the molecule AL76 has the N-terminal 76 amino acids of B. amyloliquefaciens amylase and, adjacent thereto down to the C-terminus, the homologous amino acids of B. licheniformis α-amylase, i.e. from the tyrosine present in position 79, according to the numbering of B. licheniformis α-amylase. The hybrid amylase LAL19-433, for example, consists of the N-terminal 21 amino acids of B. licheniformis α-amylase, followed by the homologous region of B. amyloliquefaciens α-amylase, i.e. starting with the tryptophan which follows the histidine in homologous complementation down to the glycine which corresponds to position 433 according to both countings, and finally of the remaining amino acids of B. licheniformis α-amylase, i.e. the region of amino acids 434 to 483. The points of fusion are also highlighted in FIG. 2.

If any uncertainties with respect to the numbering should arise from contemplating the amino acid sequences, then the corresponding nucleotide sequence as disclosed in the sequence listing is decisive, since the formation of hybrid proteins advantageously takes place at the level of the corresponding DNA. The number of the point of fusion thus results from the number of the codon downstream of whose first, second or third nucleobase the switch to the other DNA has occurred, again in each case with respect to the codon numbering of B. amyloliquefaciens (SEQ ID No. 3).

FIG. 1 diagrammatically depicts the hybrid amylases which characterize preferred embodiments of the present application. They comprise at least one sequence region, encompassing at least two amino acids, of B. amyloliquefaciens α-amylase and at least one sequence region, likewise encompassing at least two amino acids, of B. licheniformis α-amylase.

The partial sequences of the hybrid amylases, which are to be traced back to the starting molecules, are preferably more than 7, preferably more than 14, particularly preferably from 21 to 462, amino acids in length, since as, for example, FIG. 1 reveals, the partial sequences of the particularly preferred representatives (see below) are between 21 and 462 amino acids in length. Random combinations of the sites of fusion indicated there lead to proteins of the invention of at least 8 (points of fusion 76 and 84), then 15 (points of fusion 19 and 34), and finally between 21 and 462, amino acids in length.

The hybrid protein is preferably composed of three or two partial sequences complementing one another according to the starting sequences, i.e. it has one or two sites of fusion and can be assigned to any of the hybrid classes AL, LA, LAL and ALA.

The preparation of hybrid amylases of this kind according to an in-vivo method is extensively described in the publication “Hybrid Bacillus amyloliquefaciens X Bacillus licheniformis α-Amylases. Construction, properties and sequence determinants” (1995) by B. Conrad, V. Hoang, A. Polley and J. Hofemeister, Eur. J. Biochem., 230, pp. 481-490. Therein, they are obtained by in-vivo recombination. This is possible, for example, by cloning both genes one behind the other into the same vector and transforming them into a host cell (cf. H. Weber, C. Weissmann (1983): “Formation of genes coding for hybrid proteins by recombination between related, cloned genes in E. coli”, Nucleic Acid Res., 11, pp. 5661-5669, and EP 208491). This may result in a host of hybrid amylases which can be attributed to recombination events between said two genes, independently of particular restriction cleavage sites. The proteins obtained are diagrammatically indicated in FIG. 2 of the study by Conrad et al.

However, in order to carry out more than one fusion, in-vitro methods established in the prior art are more promising. Accordingly, the formation of hybrid amylases is possible by fusion both to already present and to additionally introduced restriction cleavage sites. Thus, additional cleavage sites can be introduced into both genes in question (SEQ ID No. 1 and 3) by substituting the desired nucleotides according to point mutagenesis methods known per se, for example via mismatch primers. In this connection, it is possible to utilize the degeneracy of the genetic code for generating only synonymous codons, i.e. to place only those mutations which do not influence the derived amino acid sequence. The generated restriction cleavage site can be chosen freely, since it is possible to adjust in each case also to a suitable restriction enzyme for in-vitro fusion; this applies in particular for generating unique cleavage sites. Alternatively, PCR reactions may also be carried out via partial sequences, preferably by using primers containing cleavage sites, and the products obtained may be ligated to one another.

Other possibilities of obtaining fusion proteins of this kind are, for example: (a) random recombination of appropriate fragments via methods comparable to recursive sequence recombination, as are described, for example, in the patent applications WO 98/05764, WO 97/35966, EP 590689 and EP 229046; and (b) random recombination of appropriate fragments via PCR-based methods; an example of such a method is the StEP method as described in application WO 98/42832.

The fused DNA molecules may then be cloned, amplified and expressed in host cells according to methods known per se. Systems suitable for this, such as, for example, vectors and/or host cells, are likewise known from the prior art and are offered commercially in large numbers. Readily culturable host cells with high rates of product formation are particularly suitable for industrial production of the hybrid amylases in question.

Both starting enzymes are known to be able to contribute to the washing or cleaning performance of corresponding agents, in particular with respect to starchy and starch-like stains. Thus, both wild-type molecules are the starting points for the commercially available α-amylases BAN®, and Termamyl® (manufacturer Novozymes, A/S, Bagsvaerd, Denmark). However, they have different enzymic properties, in particular with respect to thermostability. Thus, the thermostability of B. amyloliquefaciens α-amylase is distinctly lower than that of B. licheniformis (Tomazic, S. J., and Klibanov, A. M., (1988), J. Biol. Chem., 263, pp. 3086-3091 and pp. 3092-3096).

Hybrid amylases which may be obtained from the two starting enzymes in the manner described should have amylolytic activity, as may be expected on the basis of the enzymic activities of the starting enzymes and owing to the study by Conrad et al. This, however, is not necessarily tantamount to an increase in the washing or cleaning performance of corresponding agents on starchy and starch-like stains. For example it is also possible to obtain enzymes which are substantially more unstable than the starting enzymes and are thus unsuitable as component of detergents or cleaning agents. Preference will, however, be given to using them when they are capable of improving under defined conditions the washing and/or cleaning performance of at least one detergent and/or cleaning agent appropriately enriched by them.

This may be tested experimentally by preparing a formulation of a detergent or cleaning agent with or, for comparison, without an appropriate hybrid amylase and testing said formulation on its washing performance, namely in particular with respect to starch-containing soilings. Experiments of this kind are indicated in the exemplary embodiments of the present patent application.

The fusion proteins depicted in FIG. 1 of the present application and FIG. 2 of the mentioned publication by Conrad et al. have been generated by grating and de-novo fusion at those sites within the starting genes which correspond at the protein level to the following positions: 17, 34 76, 108, 112, 142, 147, 149, 151, 163, 174, 179, 185, 191, 198, 207, 231, 234, 244, 256, 263, 276, 431, 84, 99, 429, 201, 19, 433 and 153, according to the numbering of the sequence of B. amyloliquefaciens α-amylase (SEQ ID No. 2). This means that in each case the amino acid which occupies this position is followed C-terminally by an amino acid of the respective other sequence. Preferred embodiments of the present invention comprise those hybrid proteins whose sites of fusion are located within a region from 10 amino acids upstream to 10 amino acids downstream of these positions. Compared to these embodiments, preference is increasingly given to those whose sites of fusion are located within a region from 9, 8, 7, 6, 5, 4, 3, 2 or 1 amino acids upstream to 9, 8, 7, 6, 5, 4, 3, 2 or 1 amino acids downstream of these positions. And very particular preference is given to those whose points of fusion are located exactly at these positions, i.e. C-terminally thereof.

As explained above, the identity of the various partial sequences present in the hybrid proteins and the locations of fusion also determine their names. Which amino acid sequence results in the individual case can be learned on the basis of the wild-type amino acid sequences of the two starting enzymes, indicated in the sequence listing under numbers SEQ ID No. 2 and SEQ ID No. 4, and on the basis of FIG. 2.

In the publication by Conrad et al., a certain amylolytic activity has already been detected for the following special hybrid amylases: AL17, AL108, AL142, AL147, AL149, AL151, AL163, AL174, AL179, AL185, AL191, AL198, AL207, AL231, AL234, AL244, AL263, AL276, AL431, ALA17-151, ALA76-151, ALA99-429, ALA12-151, ALA112-201, LA19 and LA431. They thus characterize preferred embodiments of the present invention.

Hybrid amylases which characterize particularly preferred embodiments of this subject of the invention have points of fusion close to positions 34, 256, 84, 19 and/or 153, according to the numbering of SEQ ID No. 4. Said points of fusion are located increasingly preferably within a region from 10, 9, 8, 7, 6, 5, 4, 3, 2 and 1 amino acids upstream to increasingly preferably 10, 9, 8, 7, 6, 5, 4, 3, 2 and 1 amino acids downstream of these positions.

Preference is given here in particular to agents with the hybrid amylases AL34 (SEQ ID No. 6), AL256 (SEQ ID No. 12), ALA34-84 (SEQ ID No. 14) and/or LAL19-153 (SEQ ID No. 18), since they are capable of improving the washing or cleaning performances of corresponding formulations on starchy or starch-like stains. They partially exhibit washing or cleaning performances matching those of enzymes established in the prior art, as can be inferred from the exemplary embodiments of the present application.

Hybrid amylases which characterize particularly preferred embodiments of this subject matter of the invention have points of fusion close to positions 19, 76, 112 and/or 433 according to the numbering of SEQ ID No. 4. Said points of fusion are increasingly preferably located within a region from 10, 9, 8, 7, 6, 5, 4, 3, 2 and 1 amino acids upstream to increasingly preferably 10, 9, 8, 7, 6, 5, 4, 3, 2 and 1 amino acids downstream of these positions.

Preference is given here in particular to agents with those hybrid amylases which have, as partial sequence, the partial sequence of amino acid positions 19 to 76 of Bacillus amyloliquefaciens α-amylase (SEQ ID No. 4) and as further partial sequence, the partial sequence of amino acid positions 433 to 483 of Bacillus licheniformis α-amylase (SEQ ID No. 2).

For the study by Conrad et al., for example, discloses that the [lacuna] between positions 34 and 76 of B. amyloliquefaciens α-amylase exerts a temperature-stabilizing function for the complete molecule. It is, however, likely that not only this region is responsible for this property but that thermostability may be based on the interplay with other regions of the amylase. Thus, the enzymes which, at the same time, have the partial sequence 19 to 76 of B. amyloliquefaciens α-amylase and that of amino acid positions 433 to 483 of B. licheniformis α-amylase have shown good contributions to the washing or cleaning performances of corresponding formulations. This may result from the fact that certain, possibly still unknown, structural features confer to the enzymes under appropriate conditions (temperature, pH, ionic strength, mechanical load) the ability to remove starch or starch-like stains on fibers or hard surfaces. This is confirmed by the examples of the present application.

For this reason, very particular preference is given to those agents which comprise hybrid amylases which are at least 98% and increasingly preferably 98.25%, 98.5%, 98.75%, 99%, 99.25%, 99.5%, 99.75% and 100% identical to that of AL76 (SEQ ID No. 8) or to that of AL112 (SEQ ID No. 10) or to that of LAL19-433 (SEQ ID No. 16).

For, in the examples carried out, these enzymes have improved the washing or cleaning performance of the agents tested there on starchy or starch-like stains. Their contribution was partly equal to that of established amylases of detergents or cleaning agents or even higher.

The good washing and cleaning performances of the enzymes AL76, AL112 and LAL19-433 suggest that combination of the regions from position 19 to 76 of B. amyloliquefaciens α-amylase with the C-terminal domain of B. licheniformis α-amylase, i.e. from position 433, has a particular advantageous effect not only on the stability of the variants in question but also on the washing and cleaning performances.

The scope of protection of the homologous region of these particularly preferred enzymes AL76 (SEQ ID No. 8), AL112 (SEQ ID No. 10) and LAL19-433 (SEQ ID No. 16) includes in each case also those which can be derived from said enzymes via individual point mutations. These include increasingly preferably those having 1, 2 or 3 point mutations, preferably substitutions in the amino acid positions corresponding to positions 134, 320 and 412 according to the counting of B. licheniformis α-amylase or to positions 132, 320 and 412 according to the counting of B. amyloliquefaciens α-amylase.

Among these, preference is given in particular to the AL76 variants R132L, A318S and/or T410A (according to the counting of SEQ ID No. 8), the AL112 variants R132L, A318S and/or T410A (according to the counting of SEQ ID No. 10), and to the LAL19-433 variants Q134L, A322S and/or T414A (according to the counting of SEQ ID No. 16), since, for example, the variant AL76 R132L/A318S/T410A has given surprisingly positive results, comparable to those of AL76, in washing experiments corresponding to those of examples 2 to 7 of the present application.

Further and/or other point mutations may also be carried out in other positions of the various hybrid amylases which are increasingly preferred according to the statements made above. Among said point mutations, preference is given to substitutions of individual amino acids and, among these, very particular preference is given to those which improve a property of the amylases with respect to their use in detergents or cleaning agents. This includes, for example: stability to oxidizing conditions, to elevated temperatures, in particular between 40 and 95° C., to denaturing agents such as surfactants or complexing agents, improvement of calcium binding, adjustment of pH optimum, interaction with the substrate to be hydrolyzed or alteration of the specific or unspecific binding to the surface of the material to be cleaned.

Variations of this kind may be prepared by site-directed mutagenesis, for example via mismatch primers, as are familiar to the skilled worker from the prior art. Alternatively, it is also possible to use random methods (random mutagenesis) combined with subsequent selection for a contribution to the washing performance of a corresponding formulation of a detergent or cleaning agent. Mutagenesis methods of this kind are disclosed for hybrid amylases, for example, in the applications WO 96/23874, WO 97/41213 and WO 00/60059. Preselection of the variants obtained may be carried out as described in example 1 in the present application and they may be tested further according to the examples below.

Further embodiments of this subject matter of the invention are detergents or cleaning agents which are characterized in that they comprise a hybrid amylase relevant to the invention, obtained by deletion of in each case no more than 5 contiguous amino acids and, increasingly preferably, of in each case no more than 4, 3, 2, and, particularly preferably, of in each case only one amino acid.

Hybrid amylases of this kind may be obtained, for example, by preferably having specifically omitted shorter sequence regions in the above-described fusion of the starting sequences or else independently thereof. Said sequence regions may be, for example, relatively small destabilizing elements or losses of individual amino acids during fusion, which do not impair the washing or cleaning performance.

Further embodiments of this subject matter of the invention are detergents or cleaning agents which are characterized in that they comprise, as hybrid amylase, an amylolytic protein obtained by insertion mutation or an amylolytic chimeric protein which is identical at least in one part of one of the previously described hybrid amylases, which part confers amylolytic activity.

Thus, for example, it is possible in applying the teaching of WO 99/57250 to couple such an enzyme to a cellulose-binding domain in order to increase the interaction with the substrate. Similarly, it is also possible, for example, to fuse other detersive or cleaning-active enzymes to a hybrid amylase relevant to the invention. In principle, it is insignificant here whether the fusion takes place N- or C-terminally or via insertion; what matters is only to achieve the objective of providing a performance-improved agent.

Further embodiments of this subject matter of the invention are detergents or cleaning agents which are characterized in that they comprise an amylolytic derivative of one of the above-described hybrid amylases.

Said derivatives are, in particular, molecules which may be obtained by chemical coupling of low-molecular weight compounds or of polymers. The purpose of such a modification, for example following the teaching of WO 00/22103, may be the reduction of allergenic action, an optimization of the enzymic parameters, according to WO 99/58651, or the increase in stability, according to EP 1088887. For example, by applying the teaching of WO 00/26354 the proteins may also be modified by glycosylation.

Further embodiments of this subject matter of the invention are detergents or cleaning agents which are characterized in that they comprise an amylolytic protein or derivative which shares with one of the previously mentioned proteins or derivatives at least one antigenic determinant produced by formation of the hybrid.

For the transitions relevant to the invention from one partial sequence to the other characterize the agents improved according to the invention and the embodiments preferred accordingly. On the other hand, it is easily possible to prove via immunological cross reaction that a hybrid amylase essential to the invention is indeed active in a corresponding agent.

Agents according to the invention comprise the hybrid amylases essential to the invention or derivatives thereof preferably in amounts of from 0.000001 percent by weight to 5% by weight and, increasingly preferably, from 0.00005 to 4% by weight, from 0.00001 to 3% by weight, from 0.0001 to 2% by weight, and particularly preferably from 0.001 to 1% by weight.

The detergents or cleaning agents of the invention mean any conceivable types of cleaning agents, both concentrates and agents which can be applied in undiluted form; for use on the commercial scale, in the washing machine or for manual laundry or cleaning. They include, for example, detergents for textiles, carpets or natural fibers, for which the term detergent is used in the present invention. They also include, for example, dishwashing agents for dishwashers or manual dishwashing agents or cleaners for hard surfaces such as metal, glass, porcelain, ceramic, tiles, stone, coated surfaces, plastics, wood or leather; for those, the term cleaning agent is used in the present invention. Any type of cleaning agent is an embodiment of the present invention, as long as a protein of the invention has been added to it.

Embodiments of the present invention comprise any presentations of the agents of the invention, which are established in the prior art and/or appropriate. They include, for example, solid, pulverulent, liquid, gel-like or paste-like agents, where appropriate also composed of a plurality of phases, compressed or uncompressed; further examples include: extrudates, granules, tablets or pouches, packaged both in large containers and in portions.

Apart from an enzyme essential to the invention, the agent of the invention contains, where appropriate, further ingredients such as surfactants, for example nonionic, anionic and/or amphoteric surfactants, and/or bleaches, and/or builders, and, where appropriate, further conventional ingredients.

The nonionic surfactants used are preferably alkoxylated, advantageously ethoxylated, in particular primary alcohols having preferably from 8 to 18 carbon atoms and, on average, from 1 to 12 mol of ethylene oxide (EO) per mole of alcohol, in which the alcohol radical can be linear or, preferably, methyl-branched in the 2-position or can comprise linear and methyl-branched radicals in the mixture as are customarily present in oxo alcohol radicals. Particular preference is, however, given to alcohol ethoxylates containing linear radicals of alcohols of native origin having from 12 to 18 carbon atoms, for example from coconut, palm, tallow fatty or oleyl alcohol, and, on average, from 2 to 8 EO per mole of alcohol. Preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO, and mixtures of these, such as mixtures of C₁₂₋₁₄-alcohol having 3 EO and C₁₂₋₁₈-alcohol having 5 EO. The degrees of ethoxylation given are statistical averages which may be an integer or a fraction for a specific product. Preferred alcohol ethoxylates have a narrowed homolog distribution (narrow range ethoxylates, NRE). In addition to these nonionic surfactants, fatty alcohols having more than 12 EO can also be used. Examples thereof are tallow fatty alcohol having 14 EO, 25 EO, 30 EO or 40 EO.

A further class of preferably used nonionic surfactants which are used either as the sole nonionic surfactant or in combination with other nonionic surfactants are alkoxylated, preferably ethoxylated or ethoxylated and propoxylated fatty acid alkyl esters, preferably having from 1 to 4 carbon atoms in the alkyl chain, in particular fatty acid methyl esters.

A further class of nonionic surfactants which can advantageously be used are the alkyl polyglycosides (APG). Alkyl polyglycosides which may be used satisfy the general formula RO(G)_{z}, in which R is a linear or branched, in particular methyl-branched in the 2-position, saturated or unsaturated, aliphatic radical having from 8 to 22, preferably from 12 to 18 carbon atoms, and G is the symbol which stands for a glycose unit having 5 or 6 carbon atoms, preferably for glucose. The degree of glycosylation z is here between 1.0 and 4.0, preferably between 1.0 and 2.0 and in particular between 1.1 and 1.4. Preference is given to using linear alkyl polyglucosides, i.e. alkyl polyglycosides in which the polyglycosyl radical is a glucose radical, and the alkyl radical is an n-alkyl radical.

Nonionic surfactants of the amine oxide type, for example N-cocoalkyl-N,N-dimethylamine oxide and N-tallow alkyl-N,N-dihydroxyethylamine oxide, and of the fatty acid alkanolamides may also be suitable. The proportion of these nonionic surfactants is preferably no more than that of the ethoxylated fatty alcohols, in particular no more than half thereof.

Further suitable surfactants are polyhydroxy fatty acid amides of the formula (II) 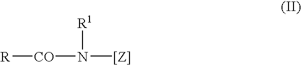
in which RCO is an aliphatic acyl radical having from 6 to 22 carbon atoms, R¹ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds of the formula (III) 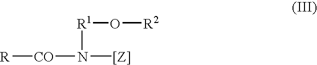
in which R is a linear or branched alkyl or alkenyl radical having from 7 to 12 carbon atoms, R¹ is a linear, branched or cyclic alkyl radical or an aryl radical having from 2 to 8 carbon atoms, and R² is a linear, branched or cyclic alkyl radical or an aryl radical or an oxy-alkyl radical having from 1 to 8 carbon atoms, where C₁₋₄-alkyl or phenyl radicals are preferred, and [Z] is a linear polyhydroxyalkyl radical whose alkyl chain is substituted with at least two hydroxyl groups, or alkoxylated, preferably ethoxylated or propoxylated, derivatives of this radical.

[Z] is preferably obtained by reductive amination of a reducing sugar, for example glucose, fructose, maltose, lactose, galactose, mannose or xylose. The N-alkoxy- or N-aryloxy-substituted compounds may be converted, for example by reaction with fatty acid methyl esters in the presence of an alkoxide as catalyst, into the desired polyhydroxy fatty acid amides.

The anionic surfactants used are, for example, those of the sulfonate and sulfate type. Suitable surfactants of the sulfonate type are preferably C₉₋₁₃-alkylbenzene sulfonates, olefin sulfonates, i.e. mixtures of alkene and hydroxyalkane sulfonates, and disulfonates, as obtained, for example, from C₁₂₋₁₈-monoolefins having a terminal or internal double bond by sulfonation with gaseous sulfur trioxide and subsequent alkaline or acidic hydrolysis of the sulfonation products. Also suitable are alkane sulfonates which are obtained from C₁₂₋₁₈-alkanes, for example, by sulfochlorination or sulfoxidation with subsequent hydrolysis or neutralization. Likewise suitable are also the esters of α-sulfo fatty acids (ester sulfonates), for example the α-sulfonated methyl esters of hydrogenated coconut, palm kernel or tallow fatty acids.

Further suitable anionic surfactants are sulfated fatty acid glycerol esters. Fatty acid glycerol esters mean the mono-, di- and triesters, and mixtures thereof, as are obtained during the preparation by esterification of a monoglycerol with from 1 to 3 mol of fatty acid or during the transesterification of triglycerides with from 0.3 to 2 mol of glycerol. Preferred sulfated fatty acid glycerol esters are here the sulfation products of saturated fatty acids having from 6 to 22 carbon atoms, for example of capronic acid, caprylic acid, capric acid, myristic acid, lauric acid, palmitic acid, stearic acid or behenic acid.

Preferred alk(en)yl sulfates are the alkali metal, and in particular the sodium, salts of sulfuric half-esters of C₁₂-C₁₈-fatty alcohols, for example of coconut fatty alcohol, tallow fatty alcohol, lauryl, myristyl, cetyl or stearyl alcohol or of C₁₀-C₂₀-oxo alcohols and those half-esters of secondary alcohols of these chain lengths. Further preferred are alk(en)yl sulfates of said chain length which comprise a synthetic, petrochemical-based straight-chain alkyl radical which have analogous degradation behavior to the equivalent compounds based on fatty chemical raw materials. From a washing performance viewpoint, preference is given to C₁₂-C₁₆-alkyl sulfates and C₁₂-C₁₅-alkyl sulfates, and C₁₄-C₁₅-alkyl sulfates. 2,3-Alkyl sulfates are also suitable anionic surfactants.

The sulfuric monoesters of straight-chain or branched C₇₋₂₁-alcohols ethoxylated with from 1 to 6 mol of ethylene oxide, such as 2-methyl-branched C₉₋₁₁-alcohols having, on average, 3.5 mol of ethylene oxide (EO) or C₁₂₋₁₈-fatty alcohols having from 1 to 4 EO, are also suitable. Owing to their high foaming behavior, they are used in cleaning agents only in relatively small amounts, for example in amounts up to 5% by weight, usually from 1 to 5% by weight.

Further suitable anionic surfactants are also the salts of alkylsulfosuccinic acid, which are also referred to as sulfosuccinates or as sulfosuccinic esters and which are monoesters and/or diesters of sulfosuccinic acid with alcohols, preferably fatty alcohols and, in particular, ethoxylated fatty alcohols. Preferred sulfosuccinates contain C₈₋₁₈-fatty alcohol radicals or mixtures thereof. Particularly preferred sulfosuccinates contain a fatty alcohol radical derived from ethoxylated fatty alcohols, which are themselves nonionic surfactants (see below for description). In this connection, sulfosuccinates whose fatty alcohol radicals are derived from ethoxylated fatty alcohols having a narrowed homolog distribution are, in turn, particularly preferred. Likewise, it is also possible to use alk(en)ylsuccinic acid having preferably from 8 to 18 carbon atoms in the alk(en)yl chain or salts thereof.

Further suitable anionic surfactants are, in particular, soaps. Saturated fatty acid soaps such as the salts of lauric acid, myristic acid, palmitic acid, stearic acid, hydrogenated erucic acid and behenic acid, and, in particular, soap mixtures derived from natural fatty acids, for example coconut, palm kernel or tallow fatty acids, are suitable.

The anionic surfactants including soaps may be present in the form of their sodium, potassium or ammonium salts, and as soluble salts of organic bases such as mono-, di- or triethanolamine. The anionic surfactants are preferably in the form of their sodium or potassium salts, in particular in the form of the sodium salts.

The surfactants may be present in the cleaning agents or detergents of the invention in an overall amount of from preferably 5% by weight to 50% by weight, in particular from 8% by weight to 30% by weight, based on the finished agent.

Agents of the invention may contain bleaches. Of the compounds which serve as bleaches and produce H₂O₂ in water, sodium percarbonate, sodium perborate tetrahydrate and sodium perborate monohydrate are of particular importance. Other bleaches which can be used are, for example, peroxopyrophosphates, citrate perhydrates and H₂O₂-producing peracidic salts or peracids, such as persulfates or persulfuric acid. Also useful is the urea peroxohydrate percarbamide which can be described by the formula H₂N—CO—NH₂.H₂O₂. In particular when used for cleaning hard surfaces, for example for machine dishwashing, the agents, if desired, may also contain bleaches from the group of organic bleaches, although the use thereof is possible in principle also in agents for washing textiles.

Typical organic bleaches are diacyl peroxides such as, for example, dibenzoyl peroxide. Further typical organic bleaches are the peroxy acids, specific examples being alkyl peroxy acids and aryl peroxy acids. Preferred representatives are peroxy benzoic acid and its ring-substituted derivatives, such as alkylperoxybenzoic acids, but also peroxy-α-naphthoic acid and magnesium monoperphthalate, the aliphatic or substituted aliphatic peroxy acids such as peroxylauric acid, peroxystearic acid, ε-phthalimidoperoxycaproic acid (phthalimidoperoxyhexanoic acid, PAP), o-carboxybenzamidoperoxycaproic acid, N-nonenylamidoperadipic acid and N-nonenylamidopersuccinate, and aliphatic and araliphatic peroxydicarboxylic acids such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid, N,N-terephthaloyl-di(6-aminopercaproic acid) may be used.

The bleach content of the agents may be from 1 to 40% by weight and, in particular, from 10 to 20% by weight, using advantageously perborate monohydrate or percarbonate. A synergistic use of amylase with percarbonate or of amylase with percarboxylic acid is disclosed by the applications wo 99/63036 and WO 99/63037, respectively.

In order to achieve improved bleaching action in cases of washing at temperatures of 60° C. and below, and in particular in the case of laundry pretreatment, the agents may also include bleach activators. Bleach activators which can be used are compounds which, under perhydrolysis conditions, give aliphatic peroxocarboxylic acids having preferably from 1 to 10 carbon atoms, in particular from 2 to 4 carbon atoms, and/or substituted or unsubstituted perbenzoic acid.

Substances which carry O- and/or N-acyl groups of said number of carbon atoms and/or substituted or unsubstituted benzoyl groups are suitable. Preference is given to plurally acylated alkylenediamines, in particular tetraacetylethylenediamine (TAED), acylated triazine derivatives, in particular 1,5-diacetyl-2,4-dioxohexahydro-1,3,5-triazine (DADHT), acylated glycoluriles, in particular 1,3,4,6-tetraacetylglycoluril (TAGU), N-acylimides, in particular N-nonanoylsuccinimide (NOSI), acylated phenol sulfonates, in particular n-nonanoyl- or isononanoyloxybenzene sulfonate (n- or iso-NOBS), acylated hydroxycarboxylic acids such as triethyl-O-acetyl citrate (TEOC), carboxylic anhydrides, in particular phthalic anhydride, isatoic anhydride and/or succinic anhydride, carboxamides such as N-methyldiacetamide, glycolide, acylated polyhydric alcohols, in particular triacetin, ethylene glycol diacetate, isopropenyl acetate, 2,5-diacetoxy-2,5-dihydrofuran and the enol esters disclosed in German patent applications DE 196 16 693 and DE 196 16 767, and acetylated sorbitol and mannitol, or mixtures thereof described in European patent application EP 0 525 239 (SORMAN), acylated sugar derivatives, in particular pentaacetylglucose (PAG), pentaacetylfructose, tetraacetylxylose and octaacetyllactose, and acetylated, optionally N-alkylated glucamine or gluconolactone, triazole or triazole derivatives and/or particulate caprolactams and/or caprolactam derivatives, preferably N-acylated lactams, for example N-benzoylcaprolactam and N-acetylcaprolactam, which are disclosed in international patent applications WO 94/27970, WO 94/28102, WO 94/28103, WO 95/00626, WO 95/14759 and WO 95/17498. The hydrophilically substituted acyl acetals disclosed in German patent application DE 196 16 769 and the acyl lactams described in German patent application DE 196 16 770 and in international patent application WO 95/14075 are likewise used with preference. It is also possible to use the combinations of conventional bleach activators disclosed in German patent application DE 44 43 177. Nitrile derivatives such as cyanopyridines, nitrile quats, e.g. N-alkylammoniumacetonitriles, and/or cyanamide derivatives may also be used. Preferred bleach activators are sodium 4-(octanoyloxy)benzenesulfonate, n-nonanoyl- or isononanoyloxybenzenesulfonate (n- or iso-NOBS), undecenoyloxybenzenesulfonate (UDOBS), sodium dodecanoyloxybenzenesulfonate (DOBS), decanoyloxybenzoic acid (DOBA, OBC 10) and/or dodecanoyloxybenzenesulfonate (OBS 12), and N-methylmorpholinium acetonitrile (MMA). Such bleach activators may be present in the customary quantitative range from 0.01 to 20% by weight, preferably in amounts from 0.1 to 15% by weight, in particular 1% by weight to 10% by weight, based on the total composition.

In addition to the conventional bleach activators or instead of them, it is also possible for “bleach catalysts” to be present. These substances are bleach-enhancing transition metal salts or transition metal complexes such as, for example, Mn, Fe, Co, Ru or Mo salene complexes or carbonyl complexes. Mn, Fe, Co, Ru, Mo, Ti, V and Cu complexes containing N-containing tripod ligands, and Co, Fe, Cu and Ru ammine complexes are also suitable as bleach catalysts, preference being given to using those compounds described in DE 197 09 284 A1. Acetonitrile derivatives, according to WO 99/63038, and bleach-activating transition metal complex compounds, according to WO 99/63041 are capable of developing a bleach-activating action in combination with amylases.

Agents of the invention usually contain one or more builders, in particular zeolites, silicates, carbonates, organic cobuilders and, where no ecological reasons oppose their use, also phosphates. The latter are the preferred builders for use in particular in cleaning agents for machine dishwashing.

Compounds which may be mentioned here are crystalline, layered sodium silicates of the general formula NaMSiₓO₂ₓ₊₁.yH₂O, where M is sodium or hydrogen, x is a number from 1.6 to 4, preferably from 1.9 to 4.0, and y is a number from 0 to 20, and preferred values for x are 2, 3 or 4. Crystalline phyllosilicates of this kind are described, for example, in European patent application EP 0 164 514. Preferred crystalline phyllosilicates of the formula indicated are those where M is sodium and x adopts the values 2 or 3. In particular, both β- and δ-sodium disilicates Na₂Si₂O₅.yH₂O are preferred. Compounds of this kind are sold, for example, under the name SKS® (Clariant). Thus, SKS-6® is primarily a δ-sodium disilicate having the formula Na₂Si₂O₅.yH₂O, and SKS-7® is primarily the β-sodium disilicate. Reacting the δ-sodium disilicate with acids (for example citric acid or carboxylic acid) gives kanemite NaHSi₂O₅.yH₂O, sold under the names SKS-9® and, respectively, SKS-10® (Clariant). It may also be advantageous to use chemical modifications of these phyllosilicates. The alkalinity of the phyllosilicates, for example, can thus be suitably influenced. Phyllosilicates doped with phosphate or with carbonate have, compared to the δ-sodium disilicate, altered crystal morphologies, dissolve more rapidly and display an increased calcium binding ability, compared to δ-sodium disilicate. Thus, phyllosilicates of the general empirical formula xNa₂O.ySiO₂.zP₂O₅ where the x-to-y ratio corresponds to a number from 0.35 to 0.6, the x-to-z ratio to a number from 1.75 to 1 200 and the y-to-z ratio to a number from 4 to 2 800 are described in patent application DE 196 01 063. The solubility of the phyllosilicates may also be increased by using particularly finely granulated phyllosilicates. It is also possible to use compounds of the crystalline phyllosilicates with other ingredients. Compounds which may be mentioned here are in particular those with cellulose derivatives which have advantageous disintegrating action and are used in particular in detergent tablets, and those with polycarboxylates, for example citric acid, or polymeric polycarboxylates, for example copolymers of acrylic acid.

It is also possible to use amorphous sodium silicates having an Na₂O:SiO₂ modulus of from 1:2 to 1:3.3, preferably from 1:2 to 1:2.8, and in particular from 1:2 to 1:2.6, which have delayed dissolution and secondary detergent properties. The dissolution delay relative to conventional amorphous sodium silicates can have been induced by various means, for example by surface treatment, compounding, compaction/compression or by overdrying. Within the scope of this invention, the term “amorphous” also means “X-ray amorphous”. This means that in X-ray diffraction experiments the silicates do not give the sharp X-ray reflections typical of crystalline substances, but give, at best, one or more maxima of these scattered X-rays, which have a width of several degree units of the diffraction angle. However, particularly good builder properties will very likely result if, in electron diffraction experiments, the silicate particles give poorly defined or even sharp diffraction maxima. This is to be interpreted to the effect that the products have microcrystalline regions with a size from 10 to a few hundred nm, preference being given to values up to at most 50 nm and in particular up to at most 20 nm. Particular preference is given to compressed/compacted amorphous silicates, compounded amorphous silicates and overdried X-ray amorphous silicates.

A finely crystalline, synthetic zeolite containing bonded water, which may be used where appropriate, is preferably zeolite A and/or P. As zeolite P, zeolite MAP® (commercial product from Crosfield) is particularly preferred. However, zeolite X and mixtures of A, X and/or P are also suitable. A product which is commercially available and can be used with preference within the scope of the present invention is, for example, also a co-crystallisate of zeolite X and zeolite A (approx. 80% by weight zeolite X), which is sold by CONDEA Augusta S.p.A. under the trade name VEGOBOND AX® and can be described by the formula
nNa₂O(1-n)K₂O.Al₂O₃.(2-2.5)SiO₂.(3.5-5.5)H₂O
Suitable zeolites have an average particle size of less than 10 μm (volume distribution; measurement method: Coulter counter) and preferably contain from 18 to 22% by weight, in particular from 20 to 22% by weight, of bonded water.

Use of the generally known phosphates as builder substances is of course also possible, provided such a use should not be avoided for ecological reasons. Among the multiplicity of commercially available phosphates, the alkali metal phosphates are the most important in the detergents and cleaning agents industry, with pentasodium or pentapotassium triphosphate (sodium or potassium tripolyphosphate) being particularly preferred.

In this connection, alkali metal phosphates is the collective term for the alkali metal (in particular sodium and potassium) salts of the various phosphoric acids, it being possible to differentiate between metaphosphoric acids (HPO₃)ₙ and orthophosphoric acid H₃PO₄ as well as higher molecular weight representatives. The phosphates combine several advantages: they act as alkali carriers, prevent lime deposits on machine parts and lime incrustations in fabrics and, moreover, contribute to the cleaning performance.

Sodium dihydrogenphosphate, NaH₂PO₄, exists as dihydrate (density 1.91 gcm⁻³, melting point 60° C.) and as monohydrate (density 2.04 gcm⁻³). Both salts are white powders which are very readily soluble in water and which lose the water of crystallization upon heating and at 200° C. convert to the weakly acidic diphosphate (disodium hydrogendiphosphate, Na₂H₂P₂O₇), at a higher temperature to sodium trimetaphosphate (Na₃P₃O₉) and Maddrell's salt (see below). NaH₂PO₄ is acidic; it forms when phosphoric acid is adjusted to a pH of 4.5 using sodium hydroxide solution and the suspension is sprayed. Potassium dihydrogenphosphate (primary or monobasic potassium phosphate, potassium biphosphate, KDP), KH₂PO₄, is a white salt of density 2.33 gcm⁻³, has a melting point of 253° [decomposition with the formation of potassium polyphosphate (KPO₃)ₓ] and is readily soluble in water.

Disodium hydrogenphosphate (secondary sodium phosphate), Na₂HPO₄, is a colorless crystalline salt which is very readily soluble in water. It exists in anhydrous form and with 2 mol (density 2.066 gcm⁻³, loss of water at 95° C.), 7 mol (density 1.68 gcm⁻³, melting point 48° C. with loss of 5H₂O) and 12 mol (density 1.52 gcm⁻³, melting point 35° C. with loss of 5H₂O) of water, becomes anhydrous at 100° C. and upon more vigorous heating converts to the diphosphate Na₄P₂O₇. Disodium hydrogenphosphate is prepared by neutralizing phosphoric acid with soda solution using phenolphthalein as indicator. Dipotassium hydrogenphosphate (secondary or dibasic potassium phosphate), K₂HPO₄, is an amorphous, white salt which is readily soluble in water.

Trisodium phosphate, tertiary sodium phosphate, Na₃PO₄, are colorless crystals which, in the form of the dodecahydrate, have a density of 1.62 gcm⁻³ and a melting point of 73-76° C. (decomposition), in the form of the decahydrate (corresponding to 19-20% P₂O₅) have a melting point of 100° C. and in anhydrous form (corresponding to 39-40% P₂O₅) have a density of 2.536 gcm⁻³. Trisodium phosphate is readily soluble in water with an alkaline reaction and is prepared by evaporating a solution of exactly 1 mol of disodium phosphate and 1 mol of NaOH. Tripotassium phosphate (tertiary or tribasic potassium phosphate), K₃PO₄, is a white, deliquescent granular powder of density 2.56 gcm⁻³, has a melting point of 1 340° C. and is readily soluble in water with an alkaline reaction. It is produced, for example, during the heating of Thomas slag with carbon and potassium sulfate. Despite the higher price, the more readily soluble, and therefore highly effective, potassium phosphates are often preferred over corresponding sodium compounds in the cleaning agents industry.

Tetrasodium diphosphate (sodium pyrophosphate), Na₄P₂O₇, exists in anhydrous form (density 2.534 gcm³, melting point 988° C., also 880° C. given) and as decahydrate (density 1.815-1.836 gcm³, melting point 94° C. with loss of water). Both substances are colorless crystals which dissolve in water with an alkaline reaction. Na₄P₂O₇ is formed during the heating of disodium phosphate to >200° C. or by reacting phosphoric acid with soda in a stoichiometric ratio and dewatering the solution by spraying. The decahydrate complexes heavy metal salts and hardness constituents and thus reduces the water hardness. Potassium diphosphate (potassium pyrophosphate), K₄P₂O₇, exists in the form of the trihydrate and is a colorless, hygroscopic powder of density 2.33 gcm⁻³, which is soluble in water, the pH of the 1% strength solution at 25° C. being 10.4.

Condensation of NaH₂PO₄ and KH₂PO₄ results in higher molecular weight sodium phosphates and potassium phosphates, respectively, amongst which cyclic representatives, the sodium and potassium metaphosphates, respectively, and chain-shaped types, the sodium and potassium polyphosphates, respectively, can be differentiated. Particularly for the latter, a multiplicity of names are in use: melt or thermal phosphates, Graham's salt, Kurrol's and Maddrell's salt. All higher sodium and potassium phosphates are together referred to as condensed phosphates.

The industrially important pentasodium triphosphate, Na₅P₃O₁₀ (sodium tripolyphosphate), is a nonhygroscopic, white, water-soluble salt which is anhydrous or crystallizes with 6H₂O and is of the general formula NaO—[P(O)(ONa)—O]-Na where n=3. In 100 g of water, about 17 g of the salt which is free of water of crystallization dissolve at room temperature, approx. 20 g dissolve at 60° C., and about 32 g dissolve at 100° C.; if the solution is heated at 100° C. for two hours, about 8% of orthophosphate and 15% of diphosphate form due to hydrolysis. In the preparation of pentasodium triphosphate, phosphoric acid is reacted with soda solution or sodium hydroxide solution in a stoichiometric ratio, and the solution is dewatered by spraying. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is available commercially, for example, in the form of a 50% strength by weight solution (>23% P₂O₅, 25% K₂O). The potassium polyphosphates are used widely in the detergents and cleaning agents industry. In addition, sodium potassium tripolyphosphates also exist which can likewise be used within the scope of the present invention. These form, for example, when sodium trimetaphosphate is hydrolyzed with KOH:
(NaPO₃)₃+2 KOH→Na₃K₂P₃O₁₀+H₂O

According to the invention, these can be used exactly as sodium tripolyphosphate, potassium tripolyphosphate or mixtures of these two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used according to the invention.

Organic cobuilders which can be used in the detergents and cleaning agents of the invention are, in particular, polycarboxylates or polycarboxylic acids, polymeric polycarboxylates, polyaspartic acid, polyacetals, optionally oxidized dextrins, further organic cobuilders (see below), and phosphonates. These classes of substance are described below.

Useable organic builder substances are, for example, the polycarboxylic acids usable in the form of their sodium salts, the term polycarboxylic acids meaning those carboxylic acids which carry more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use should not be avoided for ecological reasons, and mixtures thereof. Preferred salts are the salts of the polycarboxylic acids such as citric acid, adipic acid, succinic acid, glutaric acid, tartaric acid, sugar acids, and mixtures thereof.

It is also possible to use the acids per se. In addition to their builder action, the acids typically also have the property of an acidifying component and thus also serve to establish a lower and milder pH of detergents or cleaning agents, as long as the pH resulting from the mixture of the remaining components is not desired. Particular mention should be made here of environmentally safe acids such as citric acid, acetic acid, tartaric acid, malic acid, lactic acid, glycolic acid, succinic acid, glutaric acid, adipic acid, gluconic acid and any mixtures thereof. However, mineral acids, in particular sulfuric acid, or bases, in particular ammonium or alkali metal hydroxides, may also serve as pH regulators. The agents of the invention contain such regulators in amounts of preferably not more than 20% by weight, in particular from 1.2% by weight to 17% by weight.

Suitable builders are also polymeric polycarboxylates; these are, for example, the alkali metal salts of polyacrylic acid or of polymethacrylic acid, for example those having a relative molecular mass of from 500 to 70 000 g/mol.

The molar masses given for polymeric polycarboxylates are, for the purposes of this specification, weight-average molar masses, M_{W}, of the respective acid form, determined in principle by means of gel permeation chromatography (GPC), using a UV detector. The measurement was made against an external polyacrylic acid standard which, owing to its structural similarity toward the polymers studied, provides realistic molecular weight values. These figures differ considerably from the molecular weight values obtained using polystyrenesulfonic acids as the standard. The molar masses measured against polystyrenesulfonic acids are usually considerably higher than the molar masses given in this specification.

Suitable polymers are, in particular, polyacrylates which preferably have a molecular mass of from 2 000 to 20 000 g/mol. Owing to their superior solubility, preference in this group may be given in turn to the short-chain polyacrylates which have molar masses of from 2 000 to 10 000 g/mol, and particularly preferably from 3 000 to 5 000 g/mol.

Also suitable are copolymeric polycarboxylates, in particular those of acrylic acid with methacrylic acid and of acrylic acid or methacrylic acid with maleic acid. Copolymers which have proven to be particularly suitable are those of acrylic acid with maleic acid which contain from 50 to 90% by weight of acrylic acid and from 50 to 10% by weight of maleic acid. Their relative molecular mass, based on free acids, is generally from 2 000 to 70 000 g/mol, preferably 20 000 to 50 000 g/mol and in particular 30 000 to 40 000 g/mol. The (co)polymeric polycarboxylates may be used either as powder or as aqueous solution. The (co)polymeric polycarboxylates may be from 0.5 to 20% by weight, in particular 1 to 10% by weight of the content of the agent.

To improve the solubility in water, the polymers may also contain allylsulfonic acids such as, for example, allyloxybenzenesulfonic acid and methallylsulfonic acid as monomer.

Particular preference is also given to biodegradable polymers of more than two different monomer units, for example those which contain, as monomers, salts of acrylic acid and of maleic acid, and vinyl alcohol or vinyl alcohol derivatives, or those which contain, as monomers, salts of acrylic acid and of 2-alkylallylsulfonic acid, and sugar derivatives.

Further preferred copolymers are those which preferably have, as monomers, acrolein and acrylic acid/acrylic acid salts or acrolein and vinyl acetate.

Further preferred builder substances which may be mentioned are also polymeric aminodicarboxylic acids, their salts or their precursor substances. Particular preference is given to polyaspartic acids or salts and derivatives thereof.

Further suitable builder substances are polyacetals which can be obtained by reacting dialdehydes with polyolcarboxylic acids having from 5 to 7 carbon atoms and at least 3 hydroxyl groups. Preferred polyacetals are obtained from dialdehydes such as glyoxal, glutaraldehyde, terephthalaldehyde and mixtures thereof and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary processes, for example acid-catalyzed or enzyme-catalyzed processes. The hydrolysis products preferably have average molar masses in the range from 400 to 500 000 g/mol. Preference is given here to a polysaccharide having a dextrose equivalent (DE) in the range from 0.5 to 40, in particular from 2 to 30, where DE is a common measure of the reducing action of a polysaccharide compared with dextrose which has a DE of 100. It is possible to use both maltodextrins having a DE between 3 and 20 and dried glucose syrups having a DE between 20 and 37, and also “yellow dextrins” and “white dextrins” with higher molar masses in the range from 2 000 to 30 000 g/mol.

The oxidized derivatives of such dextrins are their reaction products with oxidation agents which are able to oxidize at least one alcohol function of the saccharide ring to the carboxylic acid function. Particularly preferred organic builders for agents of the invention are oxidized starches and derivatives thereof of the applications EP 472042, WO 97/25399 and EP 755944, respectively.

Oxydisuccinates and other derivatives of disuccinates, preferably ethylenediamine disuccinate, are also further suitable cobuilders. Here, ethylenediamine N,N′-disuccinate (EDDS) is preferably used in the form of its sodium or magnesium salts. In this connection, further preference is also given to glycerol disuccinates and glycerol trisuccinates. Suitable use amounts in zeolite-containing and/or silicate-containing formulations are between 3 and 15% by weight.

Further organic cobuilders which may be used are, for example, acetylated hydroxycarboxylic acids or salts thereof, which may also be present, where appropriate, in lactone form and which contain at least 4 carbon atoms and at least one hydroxy group and at most two acid groups.

A further class of substance having cobuilder properties is the phosphonates. These are, in particular, hydroxyalkane and aminoalkane phosphonates.

Among the hydroxyalkane phosphonates, 1-hydroxyethane 1,1-diphosphonate (HEDP) is of particular importance as a cobuilder. It is preferably used as sodium salt, the disodium salt being neutral and the tetrasodium salt being alkaline (pH 9). Suitable aminoalkane phosphonates are preferably ethylenediaminetetramethylene phosphonate (EDTMP), diethylenetriaminepentamethylene phosphonate (DTPMP) and higher homologs thereof. They are preferably used in the form of the neutral sodium salts, for example as the hexasodium salt of EDTMP or as the hepta- and octasodium salt of DTPMP. Here, preference is given to using HEDP as builder from the class of phosphonates. In addition, the aminoalkane phosphonates have a marked heavy metal-binding capacity. Accordingly, particularly if the agents also contain bleaches, it may be preferable to use aminoalkane phosphonates, in particular DTPMP, or mixtures of said phosphonates.

In addition, all compounds which are able to form complexes with alkaline earth metal ions can be used as cobuilders.

The agents of the invention may contain builder substances, where appropriate, in amounts of up to 90% by weight, and preferably contain them in amounts of up to 75% by weight. Detergents of the invention have builder contents of, in particular, from 5% by weight to 50% by weight. In inventive agents for cleaning hard surfaces, in particular for machine cleaning of dishes, the builder substance content is in particular from 5% by weight to 88% by weight, with preferably no water-insoluble builder materials being used in such agents. A preferred embodiment of inventive agents for, in particular, machine cleaning of dishes contains from 20% by weight to 40% by weight water-soluble organic builders, in particular alkali metal citrate, from 5% by weight to 15% by weight alkali metal carbonate and from 20% by weight to 40% by weight alkali metal disilicate.

Solvents which may be used in the liquid to gelatinous compositions of detergents and cleaning agents are, for example, from the group of monohydric or polyhydric alcohols, alkanolamines or glycol ethers, as long as they are miscible with water in the given concentration range. Preferably, the solvents are selected from ethanol, n- or isopropanol, butanols, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy, ethoxy or butoxy triglycol, 1-butoxyethoxy-2-propanol, 3-methyl-3-methoxybutanol, propylene glycol t-butyl ether, and mixtures of these solvents.

Solvents may be used in the liquid to gelatinous detergents and cleaning agents of the invention in amounts of between 0.1 and 20% by weight, but preferably below 15% by weight, and in particular below 10% by weight.

To adjust the viscosity, one or more thickeners or thickening systems may be added to the compositions of the invention. These high molecular weight substances which are also called swell(ing) agents usually soak up the liquids and swell in the process, converting ultimately into viscous true or colloidal solutions.

Suitable thickeners are inorganic or polymeric organic compounds. Inorganic thickeners include, for example, polysilicic acids, clay minerals, such as montmorillonites, zeolites, silicas and bentonites. The organic thickeners are from the groups of natural polymers, modified natural polymers and completely synthetic polymers. Such natural polymers are, for example, agar-agar, carrageen, tragacanth, gum arabic, alginates, pectins, polyoses, guar flour, carob seed flour, starch, dextrins, gelatins and casein. Modified natural substances which are used as thickeners are primarily from the group of modified starches and celluloses. Examples which may be mentioned here are carboxymethylcellulose and other cellulose ethers, hydroxyethylcellulose and hydroxypropylcellulose, and carob flour ether. Completely synthetic thickeners are polymers such as polyacrylic and polymethacrylic compounds, vinyl polymers, polycarboxylic acids, polyethers, polyimines, polyamides and polyurethanes.

The thickeners may be present in an amount up to 5% by weight, preferably from 0.05 to 2% by weight, and particularly preferably from 0.1 to 1.5% by weight, based on the finished composition.

The detergent and cleaning agent of the invention may, where appropriate, comprise, as further customary ingredients, sequestering agents, electrolytes and further excipients such as optical brighteners, graying inhibitors, silver corrosion inhibitors, color transfer inhibitors, foam inhibitors, abrasive substances, dyes and/or fragrances, and microbial active substances and/or UV-absorbing agents.

The textile detergents of the invention may contain, as optical brighteners, derivatives of diaminostilbenedisulfonic acid or alkali metal salts thereof. Suitable are, for example, salts of 4,4′-bis(2-anilino-4-morpholino-1,3,5-triazinyl-6-amino)stilbene-2,2′-disulfonic acid or similarly constructed compounds which carry a diethanolamino group, a methylamino group, an anilino group or a 2-methoxyethylamino group instead of the morpholino group. In addition, brighteners of the substituted diphenylstyryl type may be present, for example the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the above-mentioned optical brighteners may also be used.

Graying inhibitors have the function of keeping the soil detached from the textile fiber in suspension in the liquor. Suitable for this purpose are water-soluble colloids, usually organic in nature, for example starch, glue, gelatin, salts of ethercarboxylic acids or ethersulfonic acids of starch or of cellulose, or salts of acidic sulfuric esters of cellulose or of starch. Water-soluble polyamides containing acidic groups are also suitable for this purpose. Furthermore, starch derivatives other than those mentioned above may be used, for example aldehyde starches. Preference is given to using cellulose ethers such as carboxymethylcellulose (Na salt), methylcellulose, hydroxyalkylcellulose and mixed ethers such as methylhydroxyethylcellulose, methylhydroxypropylcellulose, methylcarboxymethylcellulose, and mixtures thereof, for example in amounts of from 0.1 to 5% by weight, based on the agents.

In order to protect against silver corrosion, silver corrosion inhibitors may be used in dishwashing cleaning agents of the invention. Such inhibitors are known in the prior art, for example benzotriazoles, iron(III) chloride or CoSO₄. As, for example, European patent EP 0 736 084 B1 discloses, silver corrosion inhibitors which are particularly suitable for being used together with enzymes are manganese, titanium, zirconium, hafnium, vanadium, cobalt or cerium salts and/or complexes in which the specified metals are present in one of the oxidation stages II, III, IV, V or VI. Examples of such compounds are MnSO₄, V₂O₅, V₂O₄, VO₂, TiOSO₄, K₂TiF₆, K₂ZrF₆, Co(NO₃) 2, Co (NO₃)₃, and mixtures thereof.

Soil-release active ingredients or soil repellents are usually polymers which, when used in a detergent, impart soil-repellent properties to the laundry fiber and/or assist the ability of the other detergent ingredients to detach soil. A comparable effect can also be observed with their use in cleaning agents for hard surfaces.

Soil-release active ingredients which are particularly effective and have been known for a long time are copolyesters having dicarboxylic acid, alkylene glycol and polyalkylene glycol units. Examples thereof are copolymers or mixed polymers of polyethylene terephthalate and polyoxyethylene glycol (DT 16 17 141, and, respectively, DT 22 00 911). German laid-open publication DT 22 53 063 discloses acidic agents containing, inter alia, a copolymer of a dibasic carboxylic acid and an alkylene or cycloalkylene polyglycol. German documents DE 28 57 292 and DE 33 24 258 and European patent EP 0 253 567 describe polymers of ethylene terephthalate and polyethylene oxide terephthalate and the use thereof in detergents. European patent EP 066 944 relates to agents containing a copolyester of ethylene glycol, polyethylene glycol, aromatic dicarboxylic acid and sulfonated aromatic dicarboxylic acid in particular molar ratios. European patent EP 0 185 427 discloses methyl or ethyl group end-group-capped polyesters having ethylene and/or propylene terephthalate and polyethylene oxide terephthalate units, and detergents containing such a soil-release polymer. European patent EP 0 241 984 discloses a polyester which contains, in addition to oxyethylene groups and terephthalic acid units, also substituted ethylene units and glycerol units. European patent EP 0 241 985 discloses polyesters which contain, in addition to oxyethylene groups and terephthalic acid units, 1,2-propylene, 1,2-butylene and/or 3-methoxy-1,2-propylene groups and glycerol units and which are end-group-capped with C₁- to C₄-alkyl groups. European patent application EP 0 272 033 discloses polyesters having polypropylene terephthalate and polyoxyethylene terephthalate units, which are at least partially end-group-capped by C₁₋₄-alkyl or acyl radicals. European patent EP 0 274 907 describes sulfoethyl end-group-capped terephthalate-containing soil-release polyesters. According to European patent application EP 0 357 280, sulfonation of unsaturated end groups produces soil-release polyesters having terephthalate, alkylene glycol and poly-C₂₋₄-glycol units. International patent application WO 95/32232 relates to acidic, aromatic polyesters capable of detaching soil. International patent application WO 97/31085 discloses nonpolymeric soil-repellent active ingredients for materials made of cotton, which have a plurality of functional units: a first unit which may be cationic, for example, is able to adsorb to the cotton surface by means of electrostatic interaction, and a second unit which is hydrophobic is responsible for the active ingredient remaining at the water/cotton interface.

The color transfer inhibitors suitable for use in laundry detergents of the invention include, in particular, polyvinylpyrrolidones, polyvinylimidazoles, polymeric N-oxides such as poly(vinylpyridine N-oxide) and copolymers of vinylpyrrolidone with vinylimidazole.

For use in machine cleaning processes, it may be of advantage to add foam inhibitors to the agents.

Examples of suitable foam inhibitors are soaps of natural or synthetic origin having a high proportion of C₁₈-C₂₄ fatty acids. Examples of suitable nonsurfactant-type foam inhibitors are organopolysiloxanes and their mixtures with microfine, optionally silanized silica and also paraffins, waxes, microcrystalline waxes, and mixtures thereof with silanized silica or bis-stearylethylenediamide. With advantages, use is also made of mixtures of different foam inhibitors, for example mixtures of silicones, paraffins or waxes. The foam inhibitors, in particular those containing silicone and/or paraffin, are preferably bound to a granular, water-soluble or dispersible support substance. Particular preference is given here to mixtures of paraffins and bis-stearylethylenediamides.

A cleaning agent of the invention for hard surfaces may, in addition, contain ingredients with abrasive action, in particular from the group comprising quartz flours, wood flours, polymer flours, chalks and glass microbeads, and mixtures thereof. Abrasives are present in the cleaning agents of the invention preferably at not more than 20% by weight, in particular from 5% by weight to 15% by weight.

Dyes and fragrances are added to detergents and cleaning agents in order to improve the esthetic appeal of the products and to provide the consumer, in addition to washing and cleaning performance, with a visually and sensorially “typical and unmistakable” product. As perfume oils and/or fragrances it is possible to use individual odorant compounds, for example the synthetic products of the ester, ether, aldehyde, ketone, alcohol and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenyl glycinate, allylcyclohexyl propionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamenaldehyde, hydroxycitronellal, lilial and bourgeonal; the ketones include, for example, the ionones, α-isomethylionone and methyl cedryl ketone; the alcohols include anethol, citronellol, eugenol, geraniol, linalool, phenylethyl alcohol, and terpineol; the hydrocarbons include primarily the terpenes such as limonene and pinene. Preference, however, is given to the use of mixtures of different odorants which together produce an appealing fragrance note. Such perfume oils may also contain natural odorant mixtures, as obtainable from plant sources, for example pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniper berry oil, vetiver oil, olibanum oil, galbanum oil and labdanum oil, and also orange blossom oil, neroli oil, orangepeel oil and sandalwood oil. The dye content of detergents and cleaning agents is usually less than 0.01% by weight, while fragrances may make up up to 2% by weight of the overall formulation.

The fragrances may be incorporated directly into the detergents and cleaning agents; however, it may also be advantageous to apply the fragrances to carriers which intensify the adhesion of the perfume to the material to be cleaned and, by means of slower fragrance release, ensure long-lasting fragrance, in particular of treated textiles. Materials which have become established as such carriers are, for example, cyclodextrins, it being possible, in addition, for the cyclodextrin-perfume complexes to be additionally coated with further auxiliaries. Another preferred carrier for fragances is the described zeolite X which can also absorb fragrances instead of or in a mixture with surfactants. Preference is therefore given to detergents and cleaning agents which contain the described zeolite X and fragrances which, preferably, are at least partially absorbed on the zeolite.

Preferred dyes whose selection is by no means difficult for the skilled worker have high storage stability and insensitivity to the other ingredients of the agents and to light, and also have no pronounced affinity for textile fibers, so as not to stain them.

To control microorganisms, detergents or cleaning agents may contain antimicrobial active ingredients. Depending on antimicrobial spectrum and mechanism of action, a distinction is made here between bacteriostatics and bactericides, fungistatics and fungicides, etc. Examples of important substances from these groups are benzalkonium chlorides, alkylaryl sulfonates, halogen phenols and phenol mercury acetate. The terms antimicrobial action and antimicrobial active ingredient have, within the teaching of the invention, the meaning common in the art, which is described, for example, by K. H. Wallhäuβer in “Praxis der Sterilisation, Desinfektion—Konservierung: Keimidentifizierung—Betriebshygiene” (5th Edition—Stuttgart; New York: Thieme, 1995), it being possible to use all of the substances having antimicrobial action described there. Suitable antimicrobial active ingredients are preferably selected from the groups of alcohols, amines, aldehydes, antimicrobial acids or their salts, carboxylic esters, acid amides, phenols, phenol derivatives, diphenyls, diphenylalkanes, urea derivatives, oxygen acetals, nitrogen acetals and also oxygen and nitrogen formals, benzamidines, isothiazolines, phthalimide derivatives, pyridine derivatives, antimicrobial surfactant compounds, guanidines, antimicrobial amphoteric compounds, quinolines, 1,2-dibromo-2,4-dicyanobutane, iodo-2-propylbutyl carbamate, iodine, iodophors, peroxo compounds, halogen compounds, and any mixtures of the above.

The antimicrobial active ingredient may be selected from ethanol, n-propanol, isopropanol, 1,3-butanediol, phenoxyethanol, 1,2-propylene glycol, glycerol, undecylenic acid, benzoic acid, salicylic acid, dihydracetic acid, o-phenylphenol, N-methylmorpholinoacetonitrile (MMA), 2-benzyl-4-chlorophenol, 2,2′-methylenebis(6-bromo-4-chlorophenol), 4,4′-dichloro-2′-hydroxydiphenyl ether (dichlosan), 2,4,4′-trichloro-2′-hydroxydiphenyl ether (trichlosan), chlorohexidine, N-(4-chlorophenyl)-N-(3,4-dichlorophenyl)urea, N,N′-(1,10-decanediyldi-1-pyridinyl-4-ylidene)bis(1-octanamine) dihydrochloride, N,N′-bis(4-chlorophenyl)-3,12-diimino-2,4,11,13-tetraazatetradecanediimidamide, glucoprotamines, anti-microbial surface-active quaternary compounds, guanidines including the bi- and polyguanidines, such as, for example, 1,6-bis(2-ethylhexylbiguanidohexane) dihydrochloride, 1,6-di (N₁, N₁′-phenyldiguanido-N₅,N₅′)hexane tetrahydrochloride, 1,6-di (N₁,N₁′-phenyl-N₁,N₁-methyldiguanido-N₅,N₅′)hexane dihydrochloride, 1,6-di (N₁, N₁′-o-chlorophenyldiguanido-N₅, N₅′) hexane dihydrochloride, 1,6-di (N₁,N₁′-2,6-dichlorophenyldiguanido-N₅,N₅′) hexane dihydrochloride, 1,6-di-[N₁,N₁′-beta-(p-methoxyphenyl)diguanido-N₅,N₅′ ]hexane dihydrochloride, 1,6-di (N₁,N₁′-alpha-methyl-betaphenyldiguanido-N₅,N₅′)hexane dihydrochloride, 1,6-di-(N₁,N₁′-p-nitrophenyldiguanido-N₅,N₅′) hexane dihydrochloride, omega:omega-di (N₁,N₁′-phenyldiguanido-N₅,N₅′)-di-n-propyl ether dihydrochloride, omega:omega′-di-(N₁, N₁′-p-chlorophenyldiguanido-N₅,N₅′)-di-n-propyl ether tetrahydrochloride, 1,6-di (N₁,N₁′-2,4-dichlorophenyldiguanido-N₅,N₅′)hexane tetrahydrochloride, 1,6-di (N₁,N₁′-p-methylphenyldiguanido-N₅,N₅′) hexane dihydrochloride, 1,6-di(N₁,N₁′-2,4,5-trichlorophenyldiguanido-N₅,N₅′)hexane tetrahydrochloride, 1,6-di-[N₁,N₁′-alpha-(p-chlorophenyl) ethyldiguanido-N₅,N₅′]-hexane dihydrochloride, omega: omega-di (N₁, N₁′-p-chlorophenyldiguanido-N₅,N₅′)m-xylene dihydrochloride, 1,12-di (N₁,N₁′-p-chlorophenyldiguanido-N₅,N₅′) dodecane dihydrochloride, 1,10-di (N₁,N₁′-phenyldiguanido-N₅,N₅′)decane tetrahydrochloride, 1,12-di (N₁,N₁′-phenyldiguanido-N₅,N₅′)dodecane tetrahydrochloride, 1,6-di (N₁,N₁′-o-chlorophenyldiguanido-N₅,N₅′) hexane dihydrochloride, 1,6-di (N₁,N₁′-o-chlorophenyldiguanido-N₅,N₅′)hexane tetrahydrochloride, ethylene-bis(1-tolylbiguanide), ethylene-bis(p-tolylbiguanide), ethylene-bis(3,5-dimethylphenylbiguanide), ethylene-bis(p-tert-amylphenylbiguanide), ethylene-bis(nonylphenylbiguanide), ethylene-bis(phenylbiguanide), ethylene-bis(N-butylphenylbiguanide), ethylene-bis(2,5-diethoxyphenylbiguanide), ethylene-bis(2,4-dimethylphenylbiguanide), ethylene-bis(o-diphenylbiguanide), ethylene-bis(mixed amyl naphthylbiguanide), N-butylethylene-bis(phenylbiguanide), trimethylenebis (o-tolylbiguanide), N-butyltrimethylbis(phenylbiguanide) and the corresponding salts such as acetates, gluconates, hydrochlorides, hydrobromides, citrates, bisulfites, fluorides, polymaleates, N-cocoalkyl sarcosinates, phosphites, hypophosphites, perfluorooctanoates, silicates, sorbates, salicylates, maleates, tartrates, fumarates, ethylenediaminetetraacetates, iminodiacetates, cinnamates, thiocyanates, arginates, pyromellitates, tetracarboxybutyrates, benzoates, glutarates, monofluorophosphates, perfluoropropionates, and any mixtures thereof. Also suitable are halogenated xylene and cresol derivatives, such as p-chlorometacresol or p-chlorometaxylene, and natural antimicrobial active ingredients of plant origin (for example from spices or herbs), animal origin and microbial origin. Preference may be given to using antimicrobial surface-active quaternary compounds, a natural antimicrobial active ingredient of plant origin and/or a natural antimicrobial active ingredient of animal origin, most preferably at least one natural antimicrobial active ingredient of plant origin from the group comprising caffeine, theobromine and theophylline and essential oils such as eugenol, thymol and geraniol, and/or at least one natural antimicrobial active ingredient of animal origin from the group comprising enzymes such as milk protein, lysozyme and lactoperoxidase, and/or at least one antimicrobial surface-active quaternary compound having an ammonium, sulfonium, phosphonium, iodonium or arsonium group, peroxo compounds and chlorine compounds. It is also possible to use substances of microbial origin, the “bacteriocines”.

The quaternary ammonium compounds (QACs) which are suitable as antimicrobial active ingredients have the general formula (R¹)(R²)(R³)(R⁴)N⁺X⁻ where R¹ to R⁴ are identical or different C₁-C₂₂-alkyl radicals, C₇-C₂₈-aralkyl radicals or heterocyclic radicals, where two, or in the case of an aromatic incorporation as in pyridine, even three radicals, together with the nitrogen atom, form the heterocycle, for example a pyridinium or imidazolinium compound, and X⁻ are halide ions, sulfate ions, hydroxide ions or similar anions. For optimal antimicrobial action, at least one of the radicals preferably has a chain length of from 8 to 18, in particular 12 to 16, carbon atoms.

QACs can be prepared by reacting tertiary amines with alkylating agents such as, for example, methyl chloride, benzyl chloride, dimethyl sulfate, dodecyl bromide, or else ethylene oxide. The alkylation of tertiary amines having one long alkyl radical and two methyl groups proceeds particularly readily, and the quaternization of tertiary amines having two long radicals and one methyl group can also be carried out with the aid of methyl chloride under mild conditions. Amines which have three long alkyl radicals or hydroxy-substituted alkyl radicals have low reactivity and are preferably quaternized using dimethyl sulfate.

Examples of suitable QACs are benzalkonium chloride (N-alkyl-N,N-dimethylbenzylammonium chloride, CAS No. 8001-54-5), benzalkone B (m,p-dichlorobenzyldimethyl-C12-alkylammonium chloride, CAS No. 58390-78-6), benzoxonium chloride (benzyldodecylbis(2-hydroxyethyl)ammonium chloride), cetrimonium bromide (N-hexadecyl-N,N-trimethylammonium bromide, CAS No. 57-09-0), benzetonium chloride (N,N-dimethyl-N-[2-[2-[p-(1,1,3,3-tetramethylbutyl)phenoxy]ethoxy]ethyl]-benzylammonium chloride, CAS No. 121-54-0), dialkyldimethylammonium chlorides such as di-n-decyldimethylammonium chloride (CAS No. 7173-51-5-5), didecyldimethylammonium bromide (CAS No. 2390-68-3), dioctyldimethylammonium chloride, 1-cetylpyridinium chloride (CAS No. 123-03-5) and thiazoline iodide (CAS No. 15764-48-1), and mixtures thereof. Particularly preferred QACs are the benzalkonium chlorides having C₈-C₁₈-alkyl radials, in particular C₁₂-C₁₄-alkylbenzyldimethylammonium chloride.

Benzalkonium halides and/or substituted benzalkonium halides are commercially available, for example, as Barquat® ex Lonza, Marquat® ex Mason, Variquat® ex Witco/Sherex and Hyamine® ex Lonza, and Bardac® ex Lonza. Further commercially available antimicrobial active ingredients are N-(3-chloroallyl)hexaminium chloride such as Dowicide® and Dowicil® ex Dow, benzethonium chloride such as Hyamine® 1622 ex Rohm & Haas, methylbenzethonium chloride such as Hyamine® 10×ex Rohm & Haas, cetylpyridinium chloride such as cepacol chloride ex Merrell Labs.

The antimicrobial active ingredients are used in amounts of from 0.0001% by weight to 1% by weight, preferably from 0.001% by weight to 0.8% by weight, particularly preferably from 0.005% by weight to 0.3% by weight, and in particular from 0.01 to 0.2% by weight.

The agents may contain UV absorbers which attach to the treated textiles and improve the light stability of the fibers and/or the light stability of other formulation constituents. UV absorbers mean organic substances (light protection filters) which are able to absorb ultraviolet radiation and to emit the absorbed energy again in the form of radiation of longer wavelength, for example heat.

Compounds which have these desired properties are, for example, the compounds which are active via radiationless deactivation and derivatives of benzophenone having substituents in position(s) 2 and/or 4. Furthermore, also suitable are substituted benzotriazoles, acrylates which are phenyl-substituted in position 3 (cinnamic acid derivatives, with or without cyano groups in position 2), salicylates, organic Ni complexes and natural substances such as umbelliferone and the endogenous urocanic acid. Of particular importance are biphenyl and especially stilbene derivatives, as described, for example, in EP 0728749 A and commercially available as Tinosorb® FD or Tinosorb® FR ex Ciba. UV-B absorbers which may be mentioned are: 3-benzylidenecamphor or 3-benzylidenenorcamphor and derivatives thereof, for example 3-(4-methylbenzylidene)camphor, as described in EP 0693471 B1; 4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylenes); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzmalonate; triazine derivatives such as, for example, 2,4,6-trianilino(p-carbo-2′-ethyl-1′-hexyloxy)-1,3,5-triazine and octyltriazone, as described in EP 0818450 A1, or dioctylbutamidotriazones (Uvasorb® HEB); propane-1,3-diones such as, for example, 1-(4-tert-butylphenyl)-3-(4′-methoxyphenyl)propane-1,3-dione; ketotricyclo(5.2.1.0)decane derivatives, as described in EP 0694521 B1. Further suitable are 2-phenylbenzimidazole-5-sulfonic acid and its alkali metal, alkaline earth metal, ammonium, alkylammonium, alkanolammonium and glucammonium salts; sulfonic acid derivatives of benzophenones, preferably 2-hydroxy-4-methoxybenzophenone-5-sulfonic acid and its salts; sulfonic acid derivatives of 3-benzylidenecamphor, such as, for example, 4-(2-oxo-3-bornylidenemethyl)benzenesulfonic acid and 2-methyl-5-(2-oxo-3-bornylidene)sulfonic acid and salts thereof.

Suitable typical UV-A filters are, in particular, derivatives of benzoylmethane, such as, for example, 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds, as described in DE 19712033 A1 (BASF). The UV-A and UV-B filters may of course also be used in mixtures. In addition to said soluble substances, insoluble light protection pigments, namely finely dispersed, preferably nanoized, metal oxides or salts, are also suitable for this purpose. Examples of suitable metal oxides are, in particular, zinc oxide and titanium dioxide and also oxides of iron, zirconium, silicon, manganese, aluminum and cerium, and mixtures thereof. Salts which may be used are silicates (talc), barium sulfate or zinc stearate. The oxides and salts are already used in the form of the pigments for skin-care and skin-protective emulsions and decorative cosmetics. The particles here should have an average diameter of less than 100 nm, preferably between 5 and 50 nm, and in particular between 15 and 30 nm. They can have a spherical shape, but it is also possible to use particles which have an ellipsoidal shape or a shape deviating in some other way from the spherical form. The pigments may also be surface-treated, i.e. hydrophilicized or hydrophobicized. Typical examples are coated titanium dioxides such as, for example, titanium dioxide T 805 (Degussa) or Eusolex® T2000 (Merck); suitable hydrophobic coating agents are here preferably silicones and, particularly preferably, trialkoxyoctylsilanes or simethicones. Preference is given to using micronized zinc oxide. Further suitable UV light protection filters can be found in the review by P. Finkel in SÖFW-Journal 122 (1996), p. 543.

The UV absorbers are usually used in amounts of from 0.01% by weight to 5% by weight, preferably from 0.03% by weight to 1% by weight.

Particularly during storage, a protein essential to the invention may be protected by stabilizers from, for example, denaturation, decay or inactivation, for example by physical influences, oxidation or proteolytic cleavage. In the case of proteins which are obtained from microorganisms, inhibition of proteolysis is particularly critical, because most microorganisms secrete various proteases as digestive enzymes into the surrounding media. Said proteases may harm considerably the proteins of interest during subsequent purification stages. In detergents and cleaning agents, too, proteins essential to the invention may be associated with proteases and therefore require particular protection.

For this purpose, inventive agents may also contain stabilizers. One group of stabilizers are reversible protease inhibitors which dissociate off when diluting the agent in the wash liquor. Benzamidine hydrochloride and leupeptin are established for this purpose.

Frequently, borax, boric acids, boronic acids or salts or esters thereof are used, including especially derivatives with aromatic groups, for example, according to WO 95/12655, ortho-substituted, according to WO 92/19707, meta-substituted and, according to U.S. Pat. No. 5,972,873, para-substituted phenylboronic acids, or salts or esters thereof. The applications WO 98/13460 and EP 583534 disclose peptide aldehydes, i.e. oligopeptides with reduced C terminus, that is those of 2-50 monomers, for the reversible inhibition of detergent and cleaning agent proteases. The peptidic reversible protease inhibitors include, inter alia, ovomucoid (WO 93/00418). For example, the application WO 00/01826 discloses specific reversible peptide inhibitors for the protease Subtilisin for use in protease-containing agents, and WO 00/01831 discloses corresponding fusion proteins of protease and inhibitor.

Further enzyme stabilizers are amino alcohols such as mono-, di-, triethanol- and -propanolamine and mixtures thereof, aliphatic carboxylic acids up to C₁₂, as disclosed, for example, by the applications EP 0378261 and WO 97/05227, such as succinic acid, other dicarboxylic acids or salts of said acids. The application DE 19650537 discloses end group-capped fatty amide alkoxylates for this purpose. As disclosed in WO 97/18287, particular organic acids used as builders are capable of additionally stabilizing a contained enzyme.

Lower aliphatic alcohols, but especially polyols such as, for example, glycerol, ethylene glycol, propylene glycol or sorbitol, are other frequently used enzyme stabilizers. According to a relatively recent application (EP 0 965 268), diglycerol phosphate also protects against denaturation due to physical influences. Calcium salts are also used, such as, for example, calcium acetate or the calcium formate disclosed for this purpose in EP 0028865, and magnesium salts, for example according to the European Application EP 0378262.

Polyamide oligomers (WO 99/43780) or polymeric compounds such as lignin (WO 97/00932), water-soluble vinyl copolymers (EP 828 762) or, as disclosed in EP 702 712, cellulose ethers, acryl polymers and/or polyamides stabilize the enzyme preparation inter alia against physical influences or pH fluctuations. Polyamine N-oxide-containing polymers (EP 587550 and EP 581751) simultaneously act as enzyme stabilizers and as color transfer inhibitors. Other polymeric stabilizers are the linear C₈-C₁₈ polyoxyalkylenes disclosed, in addition to other components, in WO 97/05227. As in the applications WO 97/43377 and WO 98/45396, alkylpolyglycosides could stabilize the enzymic components of the agent of the invention and even increase their performance. Crosslinked N-containing compounds, as disclosed in WO 98/17764, fulfill a double function as soil release agents and as enzyme stabilizers. Hydrophobic, nonionic polymer acts in a mixture together with other stabilizers, according to the application WO 97/32958, in a stabilizing manner on a cellulase so that those or similar components may also be suitable for the enzyme essential to the invention.

As disclosed inter alia in EP 780466, reducing agents and antioxidants increase the stability of the enzymes against oxidative decay. Sulfur-containing reducing agents are disclosed, for example, in EP 0080748 and EP 0080223. Other examples are sodium sulfite (EP 533239) and reducing sugars (EP 656058).

Frequently used are also combinations of stabilizers, for example of polyols, boric acid and/or borax in the application WO 96/31589, the combination of boric acid or borate, reducing salts and succinic acid or other dicarboxylic acids in the application EP 126505 or the combination of boric acid or borate with polyols or polyamino compounds and with reducing salts, as disclosed in the application EP 080223. According to WO 98/13462, the action of peptide-aldehyde stabilizers is increased by combination with boric acid and/or boric acid derivatives and polyols and, according to WO 98/13459, still further increased by the additional use of calcium ions.

Agents containing stabilized enzyme activities are preferred embodiments of the present invention. Particular preference is given to those containing enzymes stabilized in a plurality of the manners indicated.

Enzymes such as proteases, amylases, lipases or cellulases have been used for decades as active components in detergents and cleaning agents. Their particular contribution to the washing and, respectively, cleaning performance of the agent in question is, in the case of protease, the ability to break down proteinaceous soilings, in the case of amylase, the breaking-down of starch-containing soilings and, in the case of lipase, fat-cleaving activity. Cellulases are preferably used in detergents, in particular due to their contribution to the secondary washing performance of a detergent and due to their fiber action on textiles. The particular hydrolytic products are attacked, dissolved, emulsified or suspended by the other detergent or cleaning agent components or are, due to their greater solubility, washed away with the wash liquor, resulting advantageously in synergistic effects between the enzymes and the other components.

In addition to the protein essential to the invention, agents of the invention may comprise other amylolytic enzymes, in particular α-amylases. These may also include the enzymes established for use in detergents and cleaning agents. Examples of commercially available amylases are BAN®, Termamyl®, Purastar®, Amylase-LT®, Maxamyl®, Duramyl® and/or Purafect® OxAm. This applies when the various enzymes are able to complement one another. Such a complementation may take place, for example, with regard to regulation, for example by mutual activation or by inactivation. Said complementation may be caused, for example, by at least one part of the enzyme essential to the invention, which is not homologous to the known α-amylases, influencing the amylolytic activities not essential to the invention. However, combined use may also be sensible due to deviating substrate specificities. Both are embodiments of the present invention.

It may be advantageous, in particular on chemically diverse stains, to use amylolytic enzymes together with other detersive and/or cleaning-active enzymes in detergents and cleaning agents. Detergents or cleaning agents which are characterized, in addition to a protein of the invention, by additionally further enzymes are thus preferred embodiments of the present invention.

Examples thereof include, in addition to further amylases, proteases but also lipases, cutinases, esterases, pullulanases, cellulases, hemicellulases and/or xylanases, and mixtures thereof. Particular preference is given to proteases, lipases, β-glycanases and/or cellulases. Other enzymes extend the cleaning performace of corresponding agents by their in each case specific enzymic performance. These include, for example, oxidoreductases or peroxidases as components of enzymatic bleaching systems, for example laccases (WO 00/39306), β-glucanases (WO 99/06515 and WO 99/06516) or pectin-dissolving enzymes (WO 00/42145) which are used in particular in special detergents.

Examples of commercially available enzymes for use in agents of the invention are proteases such as Subtilisin BPN′, Properase®, BLAP®, Optimase®, Opticlean®, Maxatase®, Maxacal®, Maxapem®, Alcalase®, Esperase®, Savinase®, Durazym®, Everlase® and/or Purafect®G or Purafect®OxP and lipases such as Lipolase®, Lipomax®, Lumafast® and/or Lipozym®.

The protease activity in such agents may be determined according to the method described in Tenside, Vol. 7 (1970), pp. 125-132 and is, accordingly, given in PU (protease units). The protease activity of preferred agents may be up to 1 500 000 protease units per gram of preparation (PU, determined according to the method described in Tenside, Vol. 7 (1970), pp. 125-132).

Suitable among the usable enzymes, with respect to their obtainment, are primarily those from microorganisms such as bacteria or fungi, for example from Bacillus subtilis, Bacillus licheniformis, Streptomyces griseus, Humicola lanuginosa, Humicola insolens, Pseudomonas pseudoalcaligenes or Pseudomonas cepacia, in particular the enzyme mixtures naturally produced by these strains, or mixtures with those of other strains. They are obtained from suitable microorganisms via fermentation processes in a known manner, which are described, for example, in the German laid-open applications DE 19 40 488 and DE 21 21 397, the U.S. Pat. No. 3,623,957 and U.S. Pat. No. 4,264,738, the European patent application EP 006 638, and also the international patent application WO 91/02792.

These enzymes which are used in addition, where appropriate, may also be adsorbed to carriers and/or embedded in coating substances in order to protect them against premature inactivation, as described, for example, in European patent EP 0 564 476 or in the international patent applications WO 94/23005. They are present in detergents, preferably in amounts of up to 10% by weight, in particular from 0.2% by weight to 2% by weight, particular preference being given to using enzymes stabilized against oxidative degradation, as disclosed, for example, by the international patent applications WO 94/18314.

Agents of the invention may comprise a plurality of phases, for example in order to release the contained active ingredients temporally or spatially separated from one another. Said phases may be phases in various states of matter, but in particular two phases in the same states of matter.

Agents of the invention which are composed of a plurality of solid components may be prepared in a simple manner by mixing the various solid components, in particular powders, granules or extrudates having various ingredients and/or different release behavior, with one another in an overall loose mixture. Solid agents of the invention which are composed of one or more phases may be prepared in the known manner, for example by spray drying or granulation, adding the enzymes and possible further thermosensitive ingredients such as, for example, bleaches, separately later, where appropriate. To prepare agents of the invention having an increased bulk density, in particular in the range from 650 g/l to 950 g/l, preference is given to a method which has an extrusion step and has been disclosed in European patent EP 0 486 592. European patent EP 0 642 576 describes another preferred preparation with the aid of a granulation process.

Proteins may be used in dried, granulated, encapsulated, or encapsulated and additionally dried form, for example, for solid agents. They may be added separately, i.e. as independent phase, or together with other components in the same phase, with or without compaction. If microencapsulated enzymes are to be processed in solid form, it is possible to remove the water from the aqueous solutions resulting from the work-up by using methods known in the prior art, such as spray drying, removing by centrifugation or resolubilizing. The particles obtained in this way are usually between 50 and 200 μm in size.

The encapsulated form is a way of protecting the enzymes against other components such as, for example, bleaches, or of making possible a controlled release. Depending on their size, said capsules are divided into milli-, micro- and nanocapsules, microcapsules being particularly preferred for enzymes. Such capsules are disclosed, for example, in the patent applications WO 97/24177 and DE 199 18 267. Another possible encapsulation method is to encapsulate the enzymes suitable for use in detergents or cleaning agents, starting from a mixture of the enzyme solution with a solution or suspension of starch or a starch derivative, into starch or the starch derivative. The German application DE 199 56 382 describes such an encapsulation method.

A solid agent of the invention may also be provided by compression or compaction to give tablets. Such tablets may have one or more phases. Therefore, this presentation also provides the possibility of presenting a solid agent of the invention having two solid phases. To produce agents of the invention in tablet form, which may have one or more phases, may have one or more colors and/or may consist of one [lacuna] more layers, preferably all of the components—per one layer where appropriate—are mixed with one another in a mixer and the mixture is compressed by means of conventional tableting presses, for example excentric presses or rotary presses, at pressing forces in the range from about 50 to 100 kN/cm², preferably from 60 to 70 kN/cm². Especially in the case of multilayer tablets, it may be advantageous if at least one layer is compressed beforehand. This is preferably accomplished at pressing forces of between 5 and 20 kN/cm², in particular at from 10 to 15 kN/cm². A tablet produced in this way preferably has a weight of from 10 g to 50 g, in particular from 15 g to 40 g. The three-dimensional form of the tablets is arbitrary and may be circular, oval or angular, with intermediate forms also being possible.

It is particularly advantageous if at least one of the phases in multiphase agents comprises an amylase-sensitive material, in particular starch, or if it is at least partially surrounded by or coated with said material. In this way, this phase is mechanically stabilized and/or protected against influences from outside and is, at the same time, attacked via an amylase active in the wash liquor so as to facilitate release of the ingredients.

It is possible to add to liquid, gel-like or paste-like agents of the invention the enzymes, and also a protein essential to the invention, starting from protein obtainment and preparation carried out according to the prior art, in a concentrated aqueous or nonaqueous solution, for example in liquid form, for example as solution, suspension or emulsion, but also in gel form or encapsulated or as dry powder. Such inventive detergents or cleaning agents in the form of solutions in customary solvents are usually prepared by simply mixing the ingredients which may be introduced in bulk or as solution into an automatic mixer.

One embodiment of the present invention are those liquid, gel-like or paste-like agents to which a protein essential to the invention and/or one of the other proteins present and/or one of the other ingredients present has been added in the form of microcapsules. Among these, particular preference is given to those having capsules made of amylase-sensitive material. Such a combined use of amylase-sensitive materials and the amylolytic enzyme essential to the invention in a detergent or cleaning agent may show synergistic effects, for example in such a way that the starch-cleaving enzyme supports break-up of the microcapsules and thus controls the process of releasing the encapsulated ingredients so that the release thereof takes place not during storage and/or not at the beginning of the cleaning process, but only at a particular time. This mechanism may be the basis of complex detergent and cleaning agent systems comprising a large variety of ingredients and large variety of capsule types, which systems are particularly preferred embodiments of the present invention.

A comparable effect occurs if the ingredients of the detergent or cleaning agent are distributed on at least two different phases, for example two or more solid phases connected to one another of a detergent or cleaning agent in tablet form, or various granules within the same agent in powder form. Two- or multiple-phase cleaners are state of the art for application both in machine dishwashers and in detergents. The activity of an amylolytic enzyme in an earlier activated phase is a precondition for activation of a later phase if the latter is surrounded by an amylase-sensitive coat or coating or if the amylase-sensitive material is an integral component of the solid phase, which component, when partially or completely hydrolyzed, causes the phase in question to disintegrate. The use of the enzyme essential to the invention for this purpose is thus a preferred embodiment of the present invention.

The ingredients of detergents and cleaning agents are, appropriately, able to support each other's performance. The application WO 99/63035, for example, discloses the synergistic use of amylase and color transfer inhibitors in order to increase cleaning performance. It has also been disclosed, for example in application WO 98/45396, that polymers which may be used simultaneously as cobuilders, such as, for example, alkyl polyglycosides, can stabilize and increase the activity and stability of enzymes present. It is likewise possible for an amylolytic activity essential to the invention also to be modified, in particular stabilized and/or increased by one of the other components mentioned above. Appropriately adjusted formulations for agents of the invention are thus particularly preferred embodiments of the present invention.

According to the previous comments, it is also possible to improve methods for cleaning textiles or hard surfaces by a hybrid amylase essential to the invention or a derivative thereof becoming active in at least one of the method steps. Said methods are then methods of the invention.

Methods of this kind are preferably characterized by using an agent according to the previous description in at least one of the method steps.

Particularly preferably, methods of this kind are characterized by using the amylolytic protein or derivative, for example in common domestic dishwashers or domestic washing machines, preferably from 0.01 mg to 400 mg, preferably from 0.02 mg to 200 mg, particularly preferably from 0.02 mg to 100 mg of the [lacuna].

Advantageously, concentrations of from 0.0005 to 20 mg per 1, preferably 0.005 to 10 mg per 1, particularly preferably 0.005 to 8 mg, of the amylolytic protein per 1 wash liquor are obtained in this connection. The protein concentration may be determined with the aid of known methods, for example the BCA method (bicinchoninic acid; 2,2′-biquinolyl-4,4′-dicarboxylic acid) or the Biuret method (A. G. Gornall, C. S. Bardawill and M. M. David, J. Biol. Chem. 177 (1948), pp. 751-766).

According to the previous comments, the use of a hybrid amylase essential to the invention or of a derivative thereof alone or together with at least one other cleaning-active ingredient or active ingredient supporting the cleaning action for cleaning textiles or hard surfaces is also an embodiment of the present invention.

Preferably, this takes place by using an agent of the invention.

The agent of the invention or an amylolytic protein essential to the invention is preferably used in the quantity ranges indicated above so that advantageously the concentrations indicated above for the amylolytic protein in the wash liquor are obtained. Depending on the cleaning problem, the manufacturer of the agent or the end user may measure out these amounts.

Another possible use of a hybrid amylase essential to the invention or of a derivative thereof is that of activating its own or other phases when it is provided alone or together with at least one other cleaning-active ingredient or active ingredient supporting the cleaning action in a detergent or cleaning agent comprising more than one phase.

Another possible use of a hybrid amylase essential to the invention or of a derivative thereof is that for releasing the ingredients from the capsules when it is provided alone or together with at least one other cleaning-active ingredient or active ingredient supporting the cleaning action in a detergent or cleaning agent having encapsulated ingredients.

In another aspect of the present invention, methods are shown according to which it is possible to improve the washing or cleaning performance of a detergent or cleaning agent by developing new amylases. Said methods comprise fusing partial sequences, comprising in each case at least more than one amino acid, of the α-amylases of Bacillus amyloliquefaciens and Bacillus licheniformis in in each case homologous position to give an amylolytically active hybrid amylase which is added to the agent.

Methods of this kind are known per se from the prior art and are based on molecular-biological techniques as are known, for example, from the manual by Fritsch, Sambrook and Maniatis “Molecular cloning: a laboratory manual”, Cold Spring Harbour Laboratory Press, New York, 1989 or compiled in reference books such as the “Lexikon der Biochemie” [Encyclopedia of biochemistry], Spektrum Akademischer Verlag, Berlin, 1999. They are preferably based on the nucleotide sequences of the starting molecules indicated in the sequence listing under SEQ ID No. 1 and 3. The study of Conrad et al. (see above), for example, reports construction of a host of molecules via in-vivo recombination of the corresponding genes. Further possibilities of generating hybrids relevant to the invention have likewise already been introduced above.

According to the information stated above, preference is given to those methods in which the partial sequences of the hybrid amylases, which can be traced back to the starting molecules, are more than 7, preferably more than 14, particularly preferably 21 to 462, amino acids in length.

According to the information stated above, preference is given to those methods in which the hybrid protein is composed of 3 or of 2 partial sequences complementing one another according to the starting sequences.

According to the information stated above, increasing preference is given to those methods in which the points of fusion of the hybrid amylases are located within a region from 10, 9, 8, 7, 6, 5, 4, 3, 2 and 1 amino acid upstream to 10, 9, 8, 7, 6, 5, 4, 3, 2 and 1 amino acids downstream and, very particularly, exactly at one or more of positions 17, 34, 76, 108, 112, 142, 147, 149, 151, 163, 174, 179, 185, 191, 198, 207, 231, 234, 244, 256, 263, 276, 431, 84, 99, 429, 201, 19, 433 and 153, according to the numbering of SEQ ID No. 4.

According to the information stated above, increasing preference is given to those methods which comprise hybrid amylases which additionally obtain one or more deletions of in each case no more than 5, 4, 3 or 2 contiguous amino acids, particular preferably of in each case only one amino acid.

Mutations of this kind may be generated using substeps known per se, for example in connection with the fusion. They may, however, also be introduced [lacuna] other positions than the sites of fusion.

According to the information stated above, preference is given to those methods which comprise hybrid amylases which are additionally subjected to an amino acid substitution in at least one position. Increasing preference is given here to substitutions in 1, 2 or 3 of positions 132, 320 and 412, according to the counting of SEQ ID No. 4.

According to the information stated above, preference is given to those methods which comprise hybrid amylases which additionally obtain insertions or which represent an amylolytic chimeric protein.

According to the information stated above, preference is given to those methods which comprise hybrid amylases which are additionally derivatized, for example by coupling to another protein, to a polymer or by another chemical modification.

Particular preference is given in each case to those methods which are characterized by using for formation of the hybrid amylases nucleic acids which have in the corresponding partial regions the nucleotide sequences indicated in SEQ ID No. 1 and SEQ ID No. 3 or nucleotide sequences synonymous thereto. As stated above, the substitution of synonymous codons may be particularly useful if the nucleotide sequence is to be changed in order to introduce particular restriction sites, while retaining the amino acid sequence. The mutated genes obtained may be amplified, cloned and used for producing the corresponding variants in a manner known per se.

### EXAMPLES

### Example 1

Obtainment of hybrid amylases AL 34, AL76, AL112, AL 256, ALA 34-84, LAL 19-153 and LAL 19-433 and determination of enzyme activities thereof

All molecular-biological and microbiological steps follow standard methods as have been described, for example, in the manual by Fritsch, Sambrook and Maniatis “Molecular cloning: a laboratory manual”, Cold Spring Harbour Laboratory Press, New York, 1989.

Bacterial strains which produce the enzymes in question may be obtained as described in the publication “Hybrid Bacillus amyloliquefaciens X Bacillus licheniformis α-Amylases. Construction, properties and sequence determinats” (1995) by B. Conrad, V. Hoang, A. Polley and J. Hofemeister, Eur. J. Biochem., 230, pp. 481-490.

The bacterial strains expressing the hybrid amylases AL 34, AL76, AL112, AL 256, ALA 24-84, LAL 19-153 and LAL 19-433 were grown in 250-ml cultures in 1-1 shaker flasks at 37° C. and 200 rpm. The medium used was: MLBSP (10 g/l casitone; 20 g/l tryptone, 10 g/l yeast extract, in each case from Becton Dickinson, Cockeysville; 5 g/l NaCl; 27 g/l sodium succinate; 100 mg/l MgSO₄.7H₂O; 75 mg/l CaCl₁*2H₂O; 0.5 μm MnCl₂: 0.5 μM FeSO₄; 2% (w/v) glucose; 50 mM PIPES buffer (from a 1 M stock solution at pH 7.2); 75 mM KPO₄ (from a 1.5 M stock solution at pH 7.0); pH=7.0, adjusted with KOH) and 5 μg/ml chloramphenicol. In each case, 1% of the target volume of a 24-h preculture in the same medium was used for inoculation.

After 64 h, the supernatant was obtained by centrifugation at 4° C. The supernatant was stabilized with 50% propylene glycol and amylase activity in TAU was determined therefrom. For this purpose, the substrate p-nitrophenyl-α-D-maltoheptaglucoside is used whose terminal glucose unit is blocked by a benzylidene group. Said substrate is cleaved by amylase to give free p-nitrophenyl-oligosaccharide which in turn is converted to glucose and p-nitrophenol with the aid of the auxiliary enzymes glucoamylase and alpha-glucosidase. As a result, the amount of p-nitrophenol released is proportional to the amylase activity. The measurement is carried out, for example, using the QuickStart® test kit from Abbott, Abbott Park, Ill., USA. The increase in absorption (405 nm) in the assay mixture is detected by means of a spectrophotometer at 37° C. over 3 min against a blank. The calibration was carried out via an enzyme standard of known activity (e.g. Maxamyl®/Purastar® 2900 from Genencor, with 2900 TAU/g). Evaluation is carried out by plotting the difference in absorption dE (405 nm) per min as a function of the enzyme concentration of the standard. 1 TAU is the amount of enzyme which is capable under the given conditions of cleaving 1 mmol of the substrate in one minute.

Table 1 below lists the activities obtained:

TABLE 1
Activities of selected hybrid amylases

| Hybrid amylase | Activity (TAU/ml) |
|---|---|
| AL 34 | 2.5 |
| AL76 | 2.2 |
| AL112 | 4.3 |
| AL 256 | 4.9 |
| ALA 34-84 | 9.5 |
| LAL 19-153 | 2.3 |
| LAL 19-433 | 1.7 |

### Example 2

Cotton textiles were contacted in a standardized way with the following stains: A: Mousse au chocolat; B: oat flakes with cocoa, C: potato starch, and the washing performances of various detergent formulations were tested using a launderometer on the basis of the material prepared in this way. For this purpose, the liquor ratio was set in each case to 1:12, and washing was carried out at a temperature of 30° C. for 30 min. The dosage was 5.88 g of the particular detergent per 1 of wash liquor. The water hardness was 16° German hardness.

The control detergent used for A and B was a basic detergent formulation of the following composition (all values in percent by weight): 4% linear sodium alkyl benzenesulfonate (sodium salt), 4% C₁₂-C₁₈-fatty alcohol sulfate (sodium salt), 5.5% C₁₂-C₁₈-fatty alcohol with 7 EO, 1% sodium soap, 11% sodium carbonate, 2.5% amorphous sodium disilicate, 20% sodium perborate tetrahydrate, 5.5% TAED, 25% zeolite A, 4.5% polycarboxylate, 0.5% phosphonate, 2.5% foam inhibitor granules, 5% sodium sulfate, 1% protease granules, rest: water, optical brightener, perfume, salts. Said formulation was admixed for the various experimental series with different amylases, resulting in each case in a final concentration of 44 TAU of amylolytic enzyme per 1 of wash liquor.

The amylolytic enzymes essential to the invention, AL76, AL112 and LAL 19-433, were compared to Termamyl®, Duramyl® and BAN® (manufacturer in each case: Novo Nordisk A/S, Bagsværd, Denmark). For stain C, the same basic formulation was used but without protease, and, as for A and B, used as control or admixed with the amylases.

The degree of whiteness of the textiles was measured in the CIELAB system using the Minolta CR 310 instrument before and after washing and in comparison with a standard which was normalized to 100%. Table 2 below summarizes the differences of the values obtained for the particular experiments. The averages of in each case 5 measurements are listed. They allow an immediate conclusion to be drawn about the contribution of the contained enzyme to the washing performance of the agent used.

TABLE 2

| Basic detergent with | A | B | C |
|---|---|---|---|
| AL76 | 28.7 | 27.5 | 11.7 |
| AL112 | 24.1 | 24.0 | 14.3 |
| LAL19-433 | 26.4 | 26.3 | 12.5 |
| Termamyl ® | 25.9 | 22.7 | 12.3 |
| Duramyl ® | 28.6 | 23.4 | 14.3 |
| BAN ® | 22.5 | 22.0 | 13.2 |
| Control without | 22.9 | 22.2 | 10.0 |
| amylase | | | |
| Standard deviation | 1.3 | 0.6 | 2.2 |

The data show that, in the case of stain A, the hybrid amylase AL76 is at least as good as the best of the three comparative enzymes; in the case of stain B, AL76 and LAL 19-433 are distinctly superior to the latter. In the case of stain C, the hybrid amylase AL112 is as good as the best of the three comparative enzymes. The in each case remaining tested enzymes essential to the invention exhibit washing performances which are at least comparable to those of the established enzymes. These results are all the more remarkable as all agents contain a bleach and, in A and B, additionally a protease, to which contained enzymes are generally very sensitive.

### Example 3

Cotton textiles were soiled in a standardized way with the stains B (oat flakes with cocoa) and D (oat flakes with cocoa and a little milk). The test using a launderometer was carried out as in Example 2, but using a bleach-free basic detergent formulation which comprised, in each case in percent by weight: 14% sodium alkyl benzenesulfonate, 6% sodium fatty alcohol sulfonate, 6% 7 times ethoxylated C₁₂-C₁₈-fatty alcohol, 1% soap, 25% zeolite Na-A, 10% sodium carbonate, 5% polymeric polycarboxylate (Sokalan CP5), 11% trisodium citrate dihydrate, 4% citric acid, 1% particle-shaped foam inhibitor, 1% protease granules, 5% sodium sulfate, rest: water and salts. This basic formulation was mixed for the various experimental series with the different amylases, resulting in each case in a final concentration of 33.5 TAU of amylolytic enzyme per 1 of wash liquor. The hybrid amylases essential to the invention, AL76, AL112 and LAL 19-433, were compared to Termamyl®, Duramyl® and BAN® (manufacturer in each case: Novo Nordisk A/S, Bagsværd, Denmark). The dosage was 4.45 g of the particular detergent per 1 of wash liquor.

After washing, the degree of whiteness of the washed textiles was determined as in the previous example. Table 3 below summarizes the differences obtained in each case. They are, in each case, the averages of 5 measurements, which again allow an immediate conclusion to be drawn about the contribution of the particular enzyme to the washing performance of the agent.

TABLE 3

| Basic detergent with | B | D |
|---|---|---|
| AL76 | 29.5 | 17.3 |
| AL112 | 30.8 | 17.0 |
| LAL19-433 | 31.8 | 18.9 |
| Termamyl ® | 29.3 | 15.0 |
| Duramyl ® | 29.2 | 16.7 |
| BAN ® | 28.9 | 15.6 |
| Control without | 28.5 | 14.5 |
| amylase | | |
| Standard deviation | 0.6 | 1.2 |

In both cases tested, the three enzymes essential to the invention, in particular LAL19-433, exhibit, also in this bleach-free detergent formulation, such contributions to the washing performances of the agents in question, which are superior to those of the three comparative enzymes or which are, within the margin of error, at least equal thereto.

### Example 4

Cotton textiles were soiled in a standardized way with two different types of commercially available types of cocoa milk drink (E and F) and studied using a launderometer as described in Example 2. The control detergent used was the basic detergent formulation of Example 3, but without protease, which was, as in Example 3, admixed with the different amylases for the various experimental series and used at the same dosage.

After washing, the degree of whiteness of the washed textiles was measured compared to that of barium sulfate, which was normalized to 100%. The measurement was carried out in a Datacolor SF500-2 spectrometer at 460 nm (UV blocking filter 3), 30 mm diaphragm, without gloss, D65 illuminant, 10°, d/8°. Table 4 below summarizes the results obtained as percent reflectance, i.e. as percentages in comparison with barium sulfate; the respective starting values are likewise indicated there. The averages of in each case 5 measurements are listed. They allow an immediate conclusion to be drawn about the contribution of the amylolytic enzyme contained in each case on the washing performance of the agent used.

TABLE 4

| Basic detergent with | E | F |
|---|---|---|
| AL76 | 70.8 | 41.6 |
| AL112 | 70.3 | 39.2 |
| LAL19-433 | 71.4 | 40.9 |
| Termamyl ® | 67.3 | 39.7 |
| Duramyl ® | 68.3 | 40.5 |
| BAN ® | 68.7 | 39.8 |
| Control without | 61.1 | 31.4 |
| amylase | | |
| Starting value | 21.1 | 25.0 |
| Standard deviation | 1.0 | 1.2 |

In the case of stain E, all three tested hybrid amylases essential to the invention are clearly superior to the three established enzymes; in the case of stain F, they are, within the margin of error, approximately equivalent to the established enzymes.

### Example 5

Cotton textiles were contacted in a standardized way with the stains G (mashed potato with tomato puree as color indicator), H (cocoa milk drink), D (oat flakes with cocoa and a little milk), E and F (two types of commercially available types of cocoa milk drink) and studied using a launderometer under the experimental conditions stated in Example 2. The concentration of the detergent used in each case was again 5.88 g per 1 of wash liquor.

For this purpose, the basic detergent formulation indicated in Example 2 was again used, with bleach but without other enzymes. However, the α-amylases were used at a concentration of 125 TAU per 1 of wash liquor. The two hybrid amylases AL76 and LAL were tested here in comparison with the three known reference enzymes Termamyl®, Duramyl® and BAN® (manufacturer in each case: Novo Nordisk A/S, Bagsverd, Denmark).

As described in Example 2, the degree of whiteness of the textiles achieved, in percent, was determined via the CIELAB system for stains G, H and D; for stains E and F, comparative measurements with barium sulfate were carried out, as described in Example 4. The averages obtained of in each case 5 measurements are summarized in Table 5 below.

TABLE 5

| Basic | | | | | |
|---|---|---|---|---|---|
| detergent with | G | H | D | E | F |
| AL76 | 20.9 | 27.9 | 18.6 | 70.8 | 46.9 |
| LAL19-433 | 19.7 | 24.3 | 11.8 | 69.3 | 44.8 |
| Termamyl ® | 20.2 | 22.5 | 16.3 | 69.7 | 46.6 |
| Duramyl ® | 20.7 | 22.2 | 13.2 | 70.5 | 45.8 |
| BAN ® | 20.5 | 22.7 | 15.4 | 68.2 | 44.7 |
| Control | 9.9 | 20.8 | 8.7 | 55.0 | 34.6 |
| without | | | | | |
| amylase | | | | | |
| Starting value | — | — | — | 21.1 | 23.5 |
| Standard | 2.4 | 0.7 | 2.2 | 1.2 | 1.9 |
| deviation | | | | | |

For stain G, the value for hybrid amylase AL76 lies within the error bar above the highest of the three comparative enzymes, i.e. has to be regarded as at least equal. For stains H and D, AL76 shows by far the best values, followed, in the case of H, by hybrid amylase LAL and only then by the established detergent amylases used for comparison.

With stains E and F, too, AL76 does not show any lower values than the comparative enzymes, and LAL19-433 has values which are only slightly worse than those of the three comparative enzymes. This example too thus confirms that the hybrid amylases, in particular AL76 and LAL19-433, are perfectly comparable, with respect to their contribution to the washing performances of corresponding detergents, with the established enzymes.

### Example 6

Vessels with hard, smooth surfaces were contacted in a standardized way with oat flakes soaked in water and washed at 45° C. using the normal program of a domestic dishwasher type Miele® G 575.20 g of dishwashing agent were used per dishwashing run; the water hardness was 160 German hardness.

The dishwashing agent used had the following basic formulation (all values in each case in percent by weight): 55% sodium tripolyphosphate (calculated as anhydrous), 4% amorphous sodium disilicate (calculated as anhydrous), 22% sodium carbonate, 9% sodium perborate, 2% TAED, 2% nonionic surfactant, 1.4% protease granules, rest: water, dyes, perfume. This basic formulation was admixed for the various experiments with different amylases, namely Termamyl®, Duramyl® and BAN® (manufacturer in each case: Novo Nordisk A/S, Bagsværd, Denmark), or with in each case an amylolytic enzyme essential to the invention. The enzymes were used in effective amounts of in each case 150 TAU of amylolytic activity per cleaning run, as determined according to the method indicated in Example 2. The representatives used of hybrid amylases essential to the invention were: ALA34-84, AL34, AL76, AL112, AL256, LAL19-153, LAL19-433.

After washing, the stain removal was, after staining with iodine by means of the iodone-starch reaction, visually evaluated on a scale from 0 (=unchanged, i.e. very heavily soiled) to 10 (=no soiling whatsoever detectable). The results obtained are summarized in Table 6 below which lists the averages of in each case 9 measurements. They allow an immediate conclusion to be drawn about the contribution of the enzyme present to the washing performance of the agent used.

TABLE 6

| Basic detergent with | I |
|---|---|
| ALA34-84 | 1.8 |
| AL34 | 2.1 |
| AL76 | 2.1 |
| AL112 | 2.1 |
| AL256 | 2.0 |
| LAL19-153 | 1.6 |
| LAL19-433 | 2.0 |
| Termamyl ® | 1.8 |
| Duramyl ® | 2.0 |
| BAN ® | 1.7 |
| Control without | 1.3 |
| amylase | |

With this starchy stain, the three hybrid amylases AL34, AL76 and AL112 show contributions to the cleaning performances of the agents, which are above the value for the best of the three reference enzymes. Only α-amylase LAL19-153 shows a value which is below the poorest of the reference enzymes but above the control. Thus, the hybrid amylases essential to the invention exhibit at 45° C. contributions to cleaning performances of agents of the invention, which are comparable or superior to those of the enzymes established for this purpose.

### Example 7

Vessels with hard, smooth surfaces were contacted in a standardized way with the following stains: J (DIN oat flakes), I (oat flakes soaked in water) and K (starch mix).

With these, the contribution of the amylolytic enzymes in question to the cleaning performance of a dishwashing agent formulation was tested, as described in the previous example. The only difference was that washing was carried out at 55° C.

The hybrid amylases AL112, LAL19-433 and AL76 were tested accordingly, again in comparison with the α-amylases Termamyl®, Duramyl® and BAN® (manufacturer in each case: Novo Nordisk A/S, Bagsværd, Denmark). For stains J and I, evaluation was carried out visually on a scale from 0 to 10, as described in the previous example. The removal of stain K was determined gravimetrically in percent. For this purpose, the difference of the weight of the soiled and then rinsed vessel and the starting weight of the vessel was put in relation to the weight difference of the unrinsed vessel to the starting weight. This relation may be regarded as percent removal. Table 7 below depicts the result.

TABLE 7

| Basic detergent with | J | I | K |
|---|---|---|---|
| AL112 | 7.0 | 92.9 | 79.0 |
| LAL19-433 | 5.9 | 92.5 | 73.0 |
| AL76 | 7.5 | 96.9 | 90.1 |
| Termamyl ® | 6.7 | 94.5 | 53.4 |
| Duramyl ® | 6.9 | 95.1 | 88.7 |
| BAN ® | 6.2 | 92.3 | 77.3 |
| Control without | 5.3 | 70.5 | 27.2 |
| amylase | | | |

In this experiment, AL76 makes, on stain J, the distinctly largest contribution to the washing performance of the agent in question, followed by AL112 and only then by the comparative enzymes. With cleaning at 55° C., in particular, the contributions of hybrid amylase AL76 on stain I are distinctly above those of all three reference enzymes; those of the other two hybrid amylases tested are at comparable values. The same applies to stain K.

### DESCRIPTION OF THE FIGURES

FIG. 1: Construction diagram of the hybrid amylases particularly essential to the invention, AL34, AL76, AL112, AL256, ALA34-84, LAL19-153 and LAL19-433.

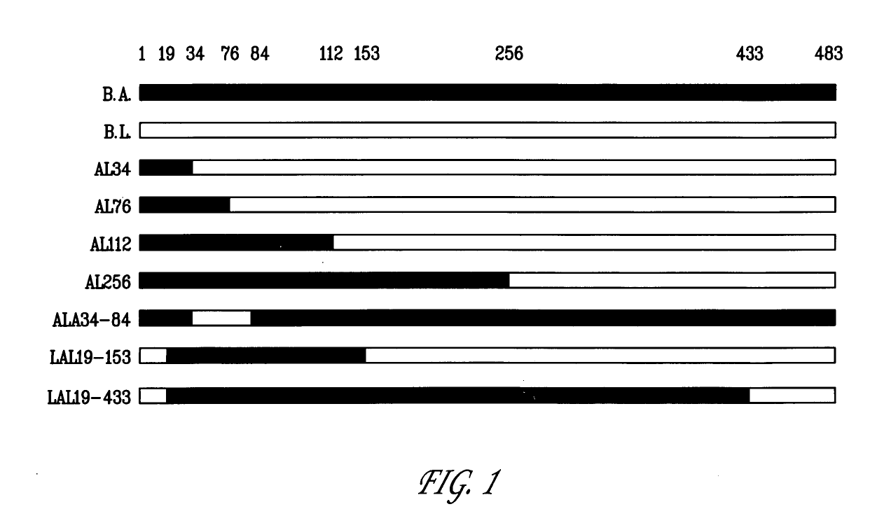

The regions indicated in each case in black are derived from B. amyloliquefaciens α-amylase (B.A.; top bar), and those indicated in white are derived from B. licheniformis α-amylase (B.L.; second bar). Above the first bar, the points of fusion are indicated in the numbering of the amino acid sequences of the mature B. amyloliquefaciens α-amylase (SEQ ID No. 4).

FIG. 2: Alignment of the amino acid sequences of the preproteins (precursors) of the α-amylases of B. licheniformis (B.L.) and B. amyloliquefaciens (B.A.).

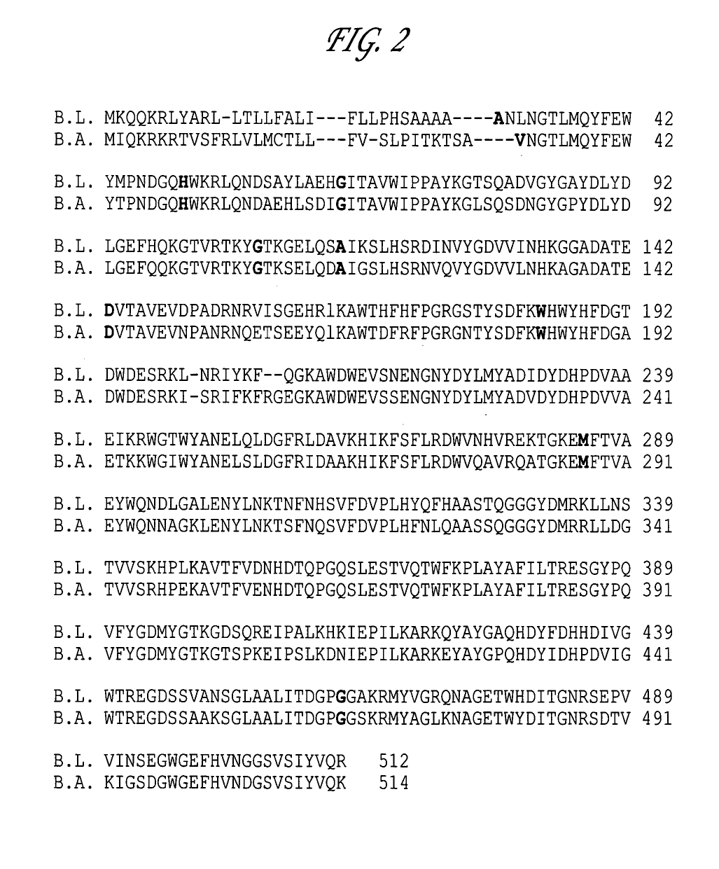

The leader peptide of B. licheniformis α-amylase comprises 29 amino acids and that of B. amyloliquefaciens α-amylase 31. The mature proteins are in each case 483 amino acids in length.

Highlighted in bold type are in each case the first amino acid of the mature protein and the amino acids corresponding to positions 19, 34, 76, 84, 112, 153, 256 and 433 in the counting of the mature B. amyloliquefaciens protein. The switches from the one to the other sequence downstream of one and, respectively, two of these positions characterize the in each case particularly preferred embodiments of the present invention.

1. A detergent or cleaning agent, characterized in that it comprises an amylolytic hybrid protein whose amino acid sequence comprises in each case in a homologous position at least one partial sequence encompassing more than one amino acid, which partial sequence is identical to that of Bacillus amyloliquefaciens α-amylase, and comprises in each case in a homologous position at least one partial sequence encompassing more than one amino acid, this partial sequence being identical to that of Bacillus licheniformis α-amylase, with the points of fusion of the hybrid amylase being located at one or more of positions 17, 34, 76, 108, 112, 142, 147, 149, 151, 163, 174, 179, 185, 191, 198, 207, 231, 234, 244, 256, 263, 276, 431, 84, 99, 429, 201, 19, 433 and 153 according to the numbering of SEQ ID No. 4.

2. The agent as claimed in claim 1, characterized in that it comprises any of the hybrid amylases AL17, AL108, AL142, AL147, AL149, AL151, AL163, AL174, AL179, AL185, AL191, AL198, AL207, AL231, AL234, AL244, AL263, AL276, AL431, ALA17-151, ALA76-151, ALA99-429, ALA112-151, ALA112-201, LA19 and/or LA431.

3. The agent as claimed in claim 1, characterized in that it comprises any of the hybrid amylases AL34 (SEQ ID No. 6), AL256 (SEQ ID No. 12), ALA34-84 (SEQ ID No. 14) and/or LAL19-153 (SEQ ID No. 18).

4. The agent as claimed in claim 1, characterized in that the hybrid proteins are those which are at least 98%, preferably 99%, particularly preferably 100%, identical to that of AL76 (SEQ ID No. 8).

5. The agent as claimed in claim 1, characterized in that the hybrid proteins are those which are at least 98%, preferably 99%, particularly preferably 100%, identical to that of AL112 (SEQ ID No. 10).

6. The agent as claimed in claim 1, characterized in that the hybrid proteins are those which are at least 98%, preferably 99%, particularly preferably 100%, identical to that of LAL19-433 (SEQ ID No. 16).

7. A detergent or cleaning agent, characterized in that it comprises a hybrid amylase as claimed in any of claims 1 to 6, obtained by deletion of in each case no more than 5 contiguous amino acids, preferably of in each case no more than 3 contiguous amino acids, particularly preferably of in each case only one amino acid, or by substitution of an amino acid.

8. A detergent or cleaning agent, characterized in that it comprises an amylolytic protein obtained by insertion mutation or an amylolytic chimeric protein which is identical at least in one part of a hybrid amylase as claimed in any of claims 1 to 7, which part confers amylolytic activity.

9. A detergent or cleaning agent, characterized in that it comprises an amylolytic derivative of a hybrid amylase as claimed in any of claims 1 to 8.

10. The agent as claimed in any of claims 1 to 9, characterized in that it comprises from 0.000001 percent by weight to 5% by weight, in particular from 0.00001 to 3% by weight, of the amylolytic protein or derivative.

11. The agent as claimed in any of claims 1 to 10, characterized in that it additionally comprises one or more other amylolytic proteins, in particular α-amylases.

12. The agent as claimed in any of claims 1 to 11, characterized in that it additionally comprises other enzymes, in particular one or more proteases, lipases, β-glucanases and/or cellulases.

13. The agent as claimed in any of claims 1 to 12, characterized in that it comprises more than one phase.

14. The agent as claimed in any of claims 1 to 13, characterized in that it is solid and that at least two different solid components, in particular powders, granules or extrudates, are present in an overall loose mixture.

15. The agent as claimed in any of claims 1 to 14, characterized in that at least two solid phases bonded together are present, in particular after a joint compacting step.

16. The agent as claimed in any of claims 13 to 15, characterized in that at least one of the phases comprises an amylase-sensitive material, in particular starch, or is, at least partly, surrounded by or coated with said material.

17. The agent as claimed in any of claims 1 to 13, characterized in that it is overall in liquid, gel or paste form and that the protein present and/or at least one of the enzymes present and/or at least one of the other components present is, either individually or together with other components, in encapsulated form, preferably in microcapsules, particularly preferably in those made of an amylase-sensitive material.

18. The agent as claimed in any of claims 1 to 17, characterized in that any of the other components of the agent modifies, in particular stabilizes, the amylolytic activity and/or increases the contribution thereof to the washing or cleaning performance of the agent.

19. A method for cleaning textiles or hard surfaces, characterized in that in at least one of the method steps an amylolytic protein or derivative as claimed in any of claims 1 to 9 becomes active.

20. A method for cleaning textiles or hard surfaces, characterized in that in at least one of the method steps an agent as claimed in any of claims 1 to 18 is used.

21. The method as claimed in claim 19 or 20, characterized in that the amylolytic protein or derivative is used in the method step in question in an amount of from 0.01 mg to 400 mg, preferably from 0.02 mg to 200 mg, particularly preferably from 0.02 to 100 mg, per application.

22. The use of an amylolytic protein or derivative as claimed in any of claims 1 to 9 alone or together with at least one other cleaning-active ingredient or active ingredient supporting the cleaning action for cleaning textiles or hard surfaces.

23. The use of an agent as claimed in any of claims 1 to 18 for cleaning textiles or hard surfaces.

24. The use as claimed in claim 22 or 23, characterized in that per application, preferably per application in a dishwasher or a washing machine, 0.01 mg to 400 mg, preferably from 0.02 mg to 200 mg, particularly preferably from 0.02 to 100 mg, of the amylolytic protein or derivative are used.

25. The use of an amylolytic protein or derivative as claimed in any of claims 1 to 9 alone or together with at least one other cleaning-active ingredient or active ingredient supporting the cleaning action in a detergent or cleaning agent comprising more than one phase for activating its own or other phases.

26. The use of an amylolytic protein or derivative as claimed in any of claims 1 to 9 alone or together with at least one other cleaning-active ingredient or active ingredient supporting the cleaning action in a detergent or cleaning agent containing encapsulated ingredients for releasing the ingredients from the capsules.

27. A method for improving the washing or cleaning performance of a detergent or cleaning agent, characterized in that partial sequences of the α-amylases from Bacillus amyloliquefaciens and Bacillus licheniformis, which in each case comprise at least more than one amino acid, are fused in each case in a homologous position to give an amylolytically active hybrid amylase and that said hybrid amylase is added to the agent, with the points of fusion of the hybrid amylase being located at one or more of positions 17, 34, 76, 108, 112, 142, 147, 149, 151, 163, 174, 179, 185, 191, 198, 207, 231, 234, 244, 256, 263, 276, 431, 84, 99, 429, 201, 19, 433 and 153 according to the numbering of SEQ ID No. 4.

28. The method as claimed in claim 27, characterized in that the hybrid amylases obtained additionally receive one or more deletions of in each case no more than 5 contiguous amino acids, preferably of in each case no more than 3 contiguous amino acids, particularly preferably of in each case only one amino acid.

29. The method as claimed in claim 27 or 28, characterized in that the hybrid amylases obtained additionally undergo an amino acid substitution in at least one position, increasingly preferably in the 1, 2 or 3 of positions 132, 320 and 412 according to the counting of SEQ ID No. 4.

30. The method as claimed in any of claims 27 to 29, characterized in that the hybrid amylases obtained additionally obtain insertions or represent an amylolytic chimeric protein.

31. The method as claimed in any of claims 27 to 30, characterized in that the hybrid amylases obtained are additionally derivatized.

32. The method as claimed in any of claims 27 to 31, characterized in that the hybrid amylases are formed by using nucleic acids which have in the corresponding partial regions the nucleotide sequences indicated in SEQ ID No. 1 and SEQ ID No. 3 or nucleotide sequences synonymous thereto.
